(19) United States
(12) Patent Application Publication
(10) Pub. No.: US 2021/0166477 A1
(43) Pub. Date: Jun. 3, 2021

(54) SYNTHESIZING IMAGES FROM 3D MODELS

(71) Applicant: Augustus Intelligence Inc., New York, NY (US)

(72) Inventors: Chenda Anne Bunkasem, New York, NY (US); Alexander D. Lavin, Brooklyn, NY (US)

(21) Appl. No.: 17/110,211

(22) Filed: Dec. 2, 2020

Related U.S. Application Data
(60) Provisional application No. 62/943,063, filed on Dec. 3, 2019.

(51) Int. Cl. G06T 17/20; G06N 20/10; G06K 9/62

(52) U.S. Cl. CPC G06T 17/20; G06T 2207/10028; G06K 9/6223; G06N 20/10

(57) ABSTRACT

Three-dimensional (“3D”) models of objects are generated and manipulated by one or more computer devices or systems to synthesize two-dimensional (“2D”) images of the objects. The 3D models are generated by capturing depth data and visual images from the objects, e.g., by scanners or cameras, and applying the visual images to a point cloud or other model formed from the depth data. A 3D model of an object may be placed in selected orientations with respect to a 2D plane, and images of the 3D model may be captured by a screen capture, an in-game camera, or another imaging technique. By varying the appearances of the 3D model, nearly limitless numbers of 2D images of the 3D model may be synthetically generated and used to train a machine learning model to recognize the object.

### CROSS-REFERENCE TO RELATED APPLICATIONS

This application claims priority to U.S. Patent Application No. 62/943,063, filed Dec. 3, 2019, the contents of which are incorporated by reference herein in their entirety.

### BACKGROUND

Machine learning algorithms, systems or techniques may be trained to associate inputted data of any type or form with a desired output. For example, where a machine learning model is desired for use in object recognition applications, a set of images or other data (e.g., a training set) may be provided to the machine learning model as inputs. Outputs received from the machine learning model in response to the inputs may be compared to a set of annotations or other identifiers of the inputs. Aspects of the machine learning model, such as weights or strengths between nodes or layers of nodes, may be adjusted until the outputs received from the machine learning model are sufficiently proximate to the annotations or other identifiers of the inputs. The machine learning model may be tested during training by providing separate sets of inputs to the machine learning model, e.g., a test set, and comparing outputs generated in response to such inputs to sets of annotations or other identifiers of the inputs. Likewise, upon completion of testing, the machine learning model may be validated by providing separate sets of inputs to the machine learning model, e.g., a validation set, and comparing outputs generated in response to such inputs to sets of annotations or other identifiers of the inputs.

Naturally, the effectiveness of a machine learning model depends on a number of factors, including but not limited to the quality of the input data (e.g., images, where the machine learning model is an object recognition model) by which the machine learning model is trained, tested or validated, and the appropriateness of the annotations or other identifiers for the input data, which are compared to outputs received in response to the input data. The availability of sufficient numbers or types of data for training a machine learning model for use in a given application is, therefore, essential to the generation and use of a machine learning model in connection with the application.

Typically, raw data (or physical data) that is intended for use in training a machine learning model is captured directly from an object, e.g., using one or more cameras or other devices, or from an open source of the data, and annotated accordingly. While such processes are effective, the raw data obtained by such processes is typically limited to the environments from which the raw data was captured, and each specimen of raw data captured must be individually annotated or identified accordingly. Because the effectiveness of the machine learning model depends on the quality of the input data and the appropriateness of the annotations or other identifiers assigned to the input data, gathering sufficient numbers or types of data for training a machine learning model may be particularly challenging.

### BRIEF DESCRIPTION OF THE DRAWINGS

FIGS. 1A through 1D are views of aspects of one system for synthesizing images from 3D models in accordance with embodiments of the present disclosure.

FIG. 2 is a block diagram of one system for synthesizing images from 3D models in accordance with embodiments of the present disclosure.

FIG. 3 is a flow chart of one process for synthesizing images from 3D models in accordance with embodiments of the present disclosure.

FIGS. 4A through 4C are views of aspects of one system for synthesizing images from 3D models in accordance with embodiments of the present disclosure.

FIGS. 5A and 5B are views of aspects of one system for synthesizing images from 3D models in accordance with embodiments of the present disclosure.

FIGS. 6A through 6E are views of aspects of one system for synthesizing images from 3D models in accordance with embodiments of the present disclosure.

FIG. 7 is a view of aspects of one system for synthesizing images from 3D models in accordance with embodiments of the present disclosure.

FIG. 8 is a flow chart of one process for synthesizing images from 3D models in accordance with embodiments of the present disclosure.

FIG. 9 is a flow chart of one process for synthesizing images from 3D models in accordance with embodiments of the present disclosure.

### DETAILED DESCRIPTION

As is set forth in greater detail below, the present disclosure is directed to synthesizing images of objects for use in training machine learning algorithms, systems or techniques based on three-dimensional (or “3D”) models of the objects. More specifically, the systems and methods of the present disclosure are directed to generating 3D models of objects by capturing imaging data and material data from the objects and generating the 3D models based on the imaging data and material data. Subsequently, the 3D models may be digitally manipulated along or about one or more axes, e.g., rotationally or translationally, or varied in their dimensions or appearance, in order to cause the 3D models to virtually appear in selected orientations. Two-dimensional (or “2D”) visual images captured of the 3D models in the selected orientations may be annotated with one or more identifiers or labels of the object and used to train a machine learning model to recognize the object, or to perform any recognition-based or vision-based task. The 2D visual images generated from the 3D models may be further placed in one or more visual contexts or scenarios that are consistent with an anticipated or intended use of the object prior to training the machine learning model, thereby increasing a likelihood that the machine learning model will be trained to recognize the object within such visual contexts or scenarios.

Thus, by generating one or more 3D models of an object that are accurate, both visually and geometrically, 2D visual images of the object may be synthetically generated from the 3D models of the object in any number, and from any perspective, such as by manipulating the object at any angular interval and about any axis, thereby resulting in sets of data for training, testing or validating machine learning models that are sufficiently large and diverse to ensure that the machine learning models are accurately trained to recognize the object in any application or for any purpose.

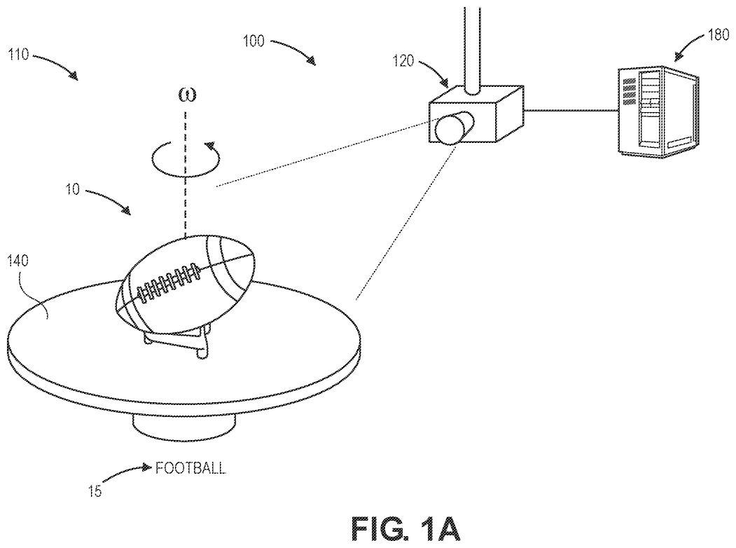

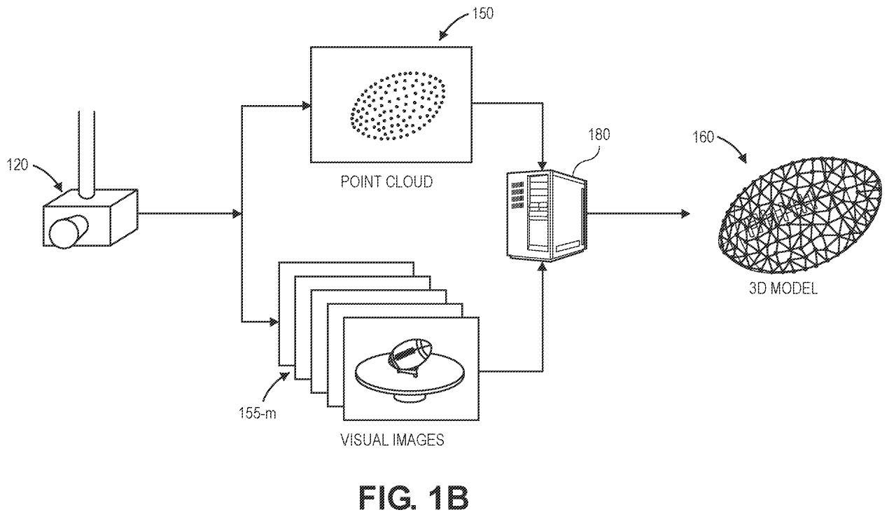

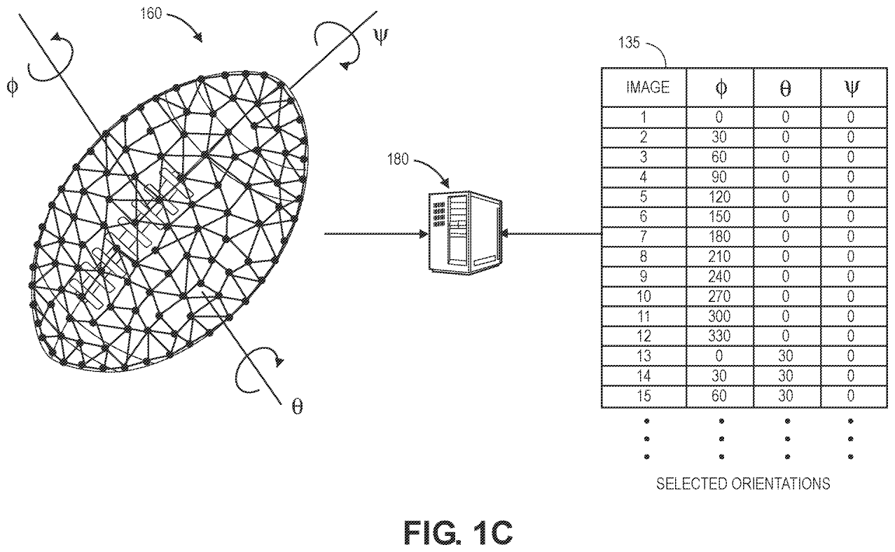

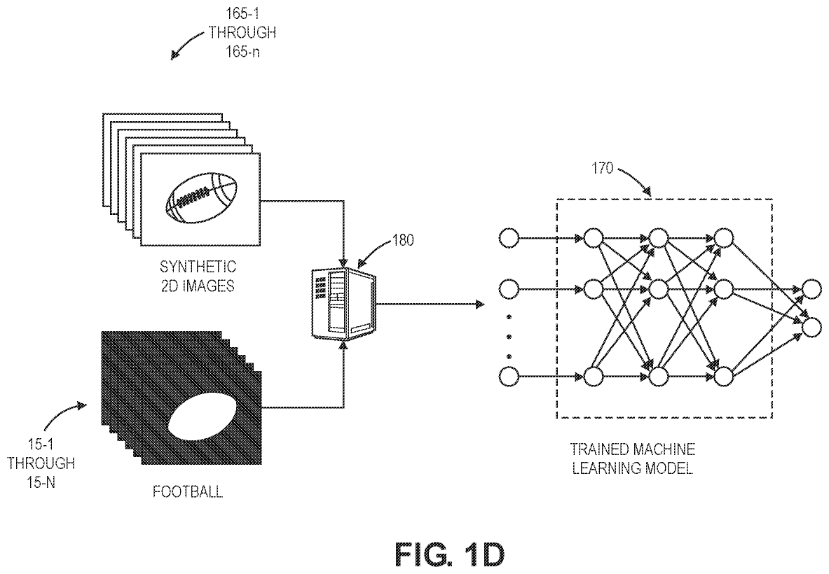

Referring to FIGS. 1A through 1D, views of aspects of one system 100 for synthesizing images from 3D models in accordance with the present disclosure are shown. As is shown in FIG. 1A, the system 100 includes an imaging facility 110 having an imaging device 120 and a turntable 140 having an object 10 thereon. The object 10 has an identifier 15 (viz., “football”).

As is also shown in FIG. 1A, the imaging device 120 includes the turntable 140 and the item 10 within a field of view, and is in communication with a server 180 or other computer device or system over one or more networks, which may include the Internet in whole or in part. The imaging device 120 is configured to capture imaging data in the form of visual imaging data (e.g., color, grayscale or black-and-white imaging data) and/or depth imaging data (e.g., ranges or distances). As is also shown in FIG. 1A, the turntable 140 is configured to rotate about an axis and at any selected angular velocity co, within the field of view of the imaging device 120. Thus, with the turntable 140 rotating at the angular velocity co, the imaging device 120 may capture imaging data (e.g., visual or depth imaging data) regarding the object 10 from different perspectives. In some embodiments, the operation of the imaging device 120 and the turntable 140 may be controlled or synchronized by one or more controllers or control systems (not shown).

As is shown in FIG. 1B, the imaging device 120 may transmit information or data regarding the object 10 to the server 180, which may process the information or data to generate a 3D model 160 of the object 10. For example, the imaging device 120 may transmit depth data regarding the object 10, e.g., a point cloud 150, a depth model, or a set of points in space corresponding to external surfaces of the object 10, or a volume occupied by the object 10, to the server 180, which may be a single computer device, or one or more computer devices, e.g., in a distributed manner. In some embodiments, the imaging device 120 may generate the point cloud 150, e.g., by one or more processors provided aboard the imaging device 120, based on one or more depth images or other sets of depth data captured by the imaging device 120, e.g., with the turntable 140 rotating at the angular velocity co and with the object 10 thereon. Alternatively, the imaging device 120 may transmit the depth images or other sets of depth data to the server 180, and the point cloud 150 may be generated by the server 180. Additionally, the imaging device 120 may also transmit a plurality of visual images 155-m (or other visual imaging data) of the object 10 to the server 180. The visual images 155-m may have been captured by the imaging device 120 at the same time as the depth data from which the point cloud 150 was generated, e.g., with the turntable 140 rotating at the angular velocity ω and with the object 10 thereon, or at a different time. The point cloud 150 or depth model (or other depth data) may be transmitted to the server 180 in any form, such as a file or record in an .OBJ file format, or any other format. Likewise, the visual images 155-m or other visual imaging data may be transmitted to the server 180 in any form, such as a file or record in a .JPG or a .BMP file format, or any other format. Alternatively, or additionally, the 3D model 160 may be generated based at least in part on material data regarding the object 10, e.g., information or data regarding textures, colors, reflectances or other properties of the respective surfaces of the object 10, in any form, such as a file or record maintained in a .MTL file format, or any other format.

In some embodiments, the 3D model 160 may be generated according to one or more photogrammetry techniques. In some embodiments, the 3D model 160 may be generated according to one or more videogrammetry techniques. In some embodiments, the 3D model 160 may be generated according to one or more panoramic stitching techniques.

The techniques by which the 3D models of the present disclosure, including but not limited to the 3D model 160, are generated are not limited.

The 3D model 160 may be a textured mesh (or polygon mesh) defined by a set of points in three-dimensional space, e.g., the point cloud 150, which may include portions of the visual images 155-m patched or mapped thereon. Alternatively, the 3D model 160 may take any other form in accordance with embodiments of the present disclosure.

As is shown in FIG. 1C, the server 180 may virtually manipulate the 3D model 160 to place the 3D model 160 in any number of orientations, or to cause the 3D model 160 to have any dimensions or appearances. For example, the 3D model 160 may be virtually rotated in accordance with a set 135 of instructions to place the 3D model 160 in one or more selected orientations defined by angles ϕ, θ, ω about axes defined with respect to the 3D model 160, with respect to a reference frame defined by a user interface shown on a video display, or according to any other standard. In some embodiments, the orientations (e.g., one or more values of the angles ϕ, θ, ω) may be selected based on a rotation quaternion, or an orientation quaternion, or on any other basis. In some embodiments, the dimensions of the 3D model 160 may be selected based on dimensions of the object 10, which may be determined based on imaging data captured using the imaging device 120 or in any other manner. In some other embodiments, however, the dimensions of the 3D model 160 may be varied by altering the positions of one or more points of the point cloud 150 or the 3D model 160, e.g., by repositioning or substituting an alternate position for one or more of such points of an .OBJ file that was used to generate the point cloud 150 or the 3D model 160, to cause the 3D model 160 to have a size that is larger than or smaller than the object 10, or to have a shape that is the same as or is different from the object 10. For example, one or more points defining a surface of the 3D model 160 may be repositioned to make the 3D model 160 have a shape that is more slender or more stout than the object 10, or has any number of eccentricities or differences from the shape of the object 10. In still other embodiments, textures, colors, reflectances or other properties of the respective surfaces of the 3D model 160 may also be varied, e.g., by varying or substituting one or more colors or textures of one or more .JPG files that were used to generate surfaces of the 3D model 160.

With the 3D model 160 in the selected orientations, or having the selected dimensions or appearances, 2D visual images of the object 10 may be synthesized or otherwise generated in any manner, e.g., by screen capture, an in-game camera, a rendering engine, or in any other manner.

As is shown in FIG. 1D, the 2D images 165-1 through 165-n and a plurality of annotations 15-1 through 15-n of the object 10, which may include one or more indicators of locations of the object 10 within the respective 2D images 165-1 through 165-n and also the identifier 15, may be used to generate and/or train a machine learning model 170, e.g., to recognize the object 10 depicted within imaging data. For example, in some embodiments, the 2D images 165-1 through 165-n may be split or parsed into a set of training images, a set of validation images, and a set of test images, along with corresponding sets of the respective annotations of each of the images. The machine learning model 170 may be trained to map inputs to desired outputs, e.g., by adjusting connections between one or more neurons in layers, in order to provide an output that most closely approximates or associates with an input to a maximum practicable extent. In accordance with embodiments of the present disclosure, any type or form of machine learning model may be generated or trained, including but not limited to artificial neural networks, deep learning systems, support vector machines, or others. In some embodiments, one or more of the 2D images 165-1 through 165-n may be augmented or otherwise modified to depict the object 10 in one or more contexts or scenarios prior to generating or training the machine learning model 170. For example, one or more of the 2D images 165-1 through 165-n generated from the 3D model 160 may be placed in a visual context or scenario that is consistent with an anticipated or intended use of the object 10, in order to generate or train the machine learning model 170 to recognize the object 10 in such contexts or scenarios.

Once the machine learning model 170 has been generated and sufficiently trained, the server 180 may distribute the machine learning model 170 to one or more end users. For example, in some embodiments, code for operating the machine learning model 170 may be transmitted to one or more end users, e.g., over one or more networks. The code may identify or represent numbers of layers or of neurons within such layers, synaptic weights between neurons, or any factors describing the operation of the machine learning model 170. Alternatively, the machine learning model 170 may be provided to one or more end users in any other manner.

Accordingly, the systems and methods of the present disclosure may generate and train a machine learning model to perform a task involving recognition or detection of an object based on 2D images of an object that are synthetically generated based on one or more 3D models of the object or obtained from an open source, as well as data that has been simulated or modified from such data.

Machine learning models may be generated, trained and utilized for the performance of any task or function in accordance with the present disclosure. For example, a machine learning model may be trained to execute any number of computer vision applications in accordance with the present disclosure. In some embodiments, a machine learning model generated according to the present disclosure may be used in medical applications, such as where images of samples of tissue or blood, or radiographic images, must be interpreted in order to properly diagnose a patient. Alternatively, a machine learning model generated according to the present disclosure may be used in autonomous vehicles, such as to enable an autonomous vehicle to detect and recognize one or more obstacles, features or other vehicles based on imaging data, and making one or more decisions regarding the safe operation of an autonomous vehicle accordingly. Likewise, a machine learning model may also be trained to execute any number of anomaly detection (or outlier detection) tasks for use in any application. In some embodiments, a machine learning model generated according to the present disclosure may be used to determine that objects such as manufactured goods, food products (e.g., fruits or meats) or faces or other identifying features of humans comply with or deviate from one or more established standards or requirements.

Any type or form of machine learning model may be generated, trained and utilized using one or more of the embodiments disclosed herein. For example, machine learning models, such as artificial neural networks, have been utilized to identify relations between respective elements of apparently unrelated sets of data. An artificial neural network is a parallel distributed computing processor system comprised of individual units that may collectively learn and store experimental knowledge, and make such knowledge available for use in one or more applications. Such a network may simulate the non-linear mental performance of the many neurons of the human brain in multiple layers by acquiring knowledge from an environment through one or more flexible learning processes, determining the strengths of the respective connections between such neurons, and utilizing such strengths when storing acquired knowledge. Like the human brain, an artificial neural network may use any number of neurons in any number of layers. In view of their versatility, and their inherent mimicking of the human brain, machine learning models including not only artificial neural networks but also deep learning systems, support vector machines, nearest neighbor methods or analyses, factorization methods or techniques, K-means clustering analyses or techniques, similarity measures such as log likelihood similarities or cosine similarities, latent Dirichlet allocations or other topic models, decision trees, or latent semantic analyses have been utilized in many applications, including but not limited to computer vision applications, anomaly detection applications, and voice recognition or natural language processing.

Artificial neural networks may be trained to map inputted data to desired outputs by adjusting strengths of connections between one or more neurons, which are sometimes called synaptic weights. An artificial neural network may have any number of layers, including an input layer, an output layer, and any number of intervening hidden layers. Each of the neurons in a layer within a neural network may receive an input and generate an output in accordance with an activation or energy function, with parameters corresponding to the various strengths or synaptic weights. For example, in a heterogeneous neural network, each of the neurons within the network may be understood to have different activation or energy functions. In some neural networks, at least one of the activation or energy functions may take the form of a sigmoid function, wherein an output thereof may have a range of zero to one or 0 to 1. In other neural networks, at least one of the activation or energy functions may take the form of a hyperbolic tangent function, wherein an output thereof may have a range of negative one to positive one, or −1 to +1. Thus, the training of a neural network according to an identity function results in the redefinition or adjustment of the strengths or weights of such connections between neurons in the various layers of the neural network, in order to provide an output that most closely approximates or associates with the input to the maximum practicable extent.

Artificial neural networks may typically be characterized as either feedforward neural networks or recurrent neural networks, and may be fully or partially connected. In a feedforward neural network, e.g., a convolutional neural network, information may specifically flow in one direction from an input layer to an output layer, while in a recurrent neural network, at least one feedback loop returns information regarding the difference between the actual output and the targeted output for training purposes. Additionally, in a fully connected neural network architecture, each of the neurons in one of the layers is connected to all of the neurons in a subsequent layer. By contrast, in a sparsely connected neural network architecture, the number of activations of each of the neurons is limited, such as by a sparsity parameter.

Moreover, the training of a neural network is typically characterized as supervised or unsupervised. In supervised learning, a training set comprises at least one input and at least one target output for the input. Thus, the neural network is trained to identify the target output, to within an acceptable level of error. In unsupervised learning of an identity function, such as that which is typically performed by a sparse autoencoder, target output of the training set is the input, and the neural network is trained to recognize the input as such. Sparse autoencoders employ backpropagation in order to train the autoencoders to recognize an approximation of an identity function for an input, or to otherwise approximate the input. Such backpropagation algorithms may operate according to methods of steepest descent, conjugate gradient methods, or other like methods or techniques, in accordance with the systems and methods of the present disclosure. Those of ordinary skill in the pertinent art would recognize that any algorithm or method may be used to train one or more layers of a neural network. Likewise, any algorithm or method may be used to determine and minimize errors in an output of such a network. Additionally, those of ordinary skill in the pertinent art would further recognize that the various layers of a neural network may be trained collectively, such as in a sparse autoencoder, or individually, such that each output from one hidden layer of the neural network acts as an input to a subsequent hidden layer.

Once a neural network has been trained to recognize dominant characteristics of an input of a training set, e.g., to associate a point or a set of data such as an image with a label to within an acceptable tolerance, an input in the form of a data point may be provided to the trained network, and a label may be identified based on the output thereof.

In accordance with embodiments of the present disclosure, 2D images of objects that are synthetically generated from 3D models of the object may be subject to one or more annotation processes in which regions of such images, or objects depicted therein, are designated accordingly. In computer vision applications, annotation is commonly known as marking or labeling of images or video files captured from a scene, such as to denote the presence and location of one or more objects or other features within the scene in the images or video files. Annotating a video file typically involves placing a virtual marking such as a box or other shape on an image frame of a video file, thereby denoting that the image frame depicts an item, or includes pixels of significance, within the box or shape. In some embodiments, the 2D images may be automatically annotated by pixel-wise segmentation, to identify locations of the depicted 3D models within the 2D visual images. For example, an annotation may take the form of an automatically generated bitmap indicating locations corresponding to the 3D models depicted within a 2D visual image in a first color (e.g., white or black), and locations not corresponding to the 3D models depicted within the 2D visual image in a second color (e.g., black or white). In some other embodiments, annotations of 2D visual images that are images of objects that are synthetically generated from 3D models of the object may include any other information, data or metadata, at any level or degree of richness regarding contents of the 2D visual images, including not only contextual annotations, semantic annotations, background annotations, or any other types or forms of annotations.

Alternatively, in some embodiments, a video file may be annotated by applying markings or layers including alphanumeric characters, hyperlinks or other markings on specific frames of the video file, thereby enhancing the functionality or interactivity of the video file in general, or of the video frames in particular. In some other embodiments, annotation may involve generating a table or record identifying positions of objects depicted within image frames, e.g., by one or more pairs of coordinates.

Variations in dimensions or appearances of 3D models of an object may be selected on any basis, such as known attributes of the object, or like objects. For example, in some embodiments, where a 3D model of a ripe Granny Smith apple is generated based on depth data, visual imaging data and material data regarding the apple, one or more visual aspects of the 3D model may be varied to synthesize 2D visual images of Granny Smith apples at various stages of ripeness using the 3D model, e.g., by whitening the skin color to cause the 3D model to have an appearance of an under-ripe Granny Smith apple, or imparting red or pink colors to portions of the skin color to cause the 3D model to have an appearance of an over-ripe Granny Smith apple. Alternatively, in some embodiments, one or more surfaces of the 3D model may also be varied to cause the 3D model to appear larger or smaller than the actual Granny Smith apple, or to cause the 3D model to have sizes consistent with various stages of a lifecycle of a Granny Smith apple. Once a 3D model of an object has been constructed in accordance with embodiments of the present disclosure, any attributes of the 3D model may be varied in order to cause the 3D model to appear differently, and to enable a broader variety of 2D visual images of the object to be synthesized using the 3D model.

Moreover, where a 3D model is generated for a face or other skin-covered body part, the systems and methods of the present disclosure may be particularly useful in combating observed racial bias in machine learning outcomes. For example, where a 3D model is generated of a given human face featuring a given skin color or hair color, the visual appearance of the 3D model may be modified to vary skin colors or hair colors, e.g., to mimic or represent skin colors or hair colors for humans of different races or ethnic backgrounds. Subsequently, 2D visual images of the human face may be generated with any number of skin colors or hair colors, and utilized to increase the amount of available visual imaging data for generating or training machine learning models, or testing or validating the machine learning models, and to increase the accuracy or reliability of the machine learning models.

In some embodiments, 2D visual images of objects that are synthetically generated from 3D models of the object may be split or parsed into training sets, validation sets or test sets, each having any size or containing any proportion of the total number of 2D visual images. Once a machine learning model has been sufficiently trained, validated and tested by an artificial intelligence engine, the model may be distributed to one or more end users, e.g., over a network. Subsequently, in some embodiments, end users that receive a trained machine learning model for performing a task may return feedback regarding the performance or the efficacy of the model, including the accuracy or efficiency of the model in performing the task for which the model was generated. The feedback may take any form, including but not limited to one or more measures of the effectiveness of the machine learning model in performing a given task, including an identification of one or more sets of data regarding inaccuracies of the model in interpreting inputs and generating outputs for performing the task.

The systems and methods of the present disclosure are not limited to use in any of the embodiments disclosed herein, including but not limited to object recognition, computer vision or anomaly detection applications. For example, one or more of the machine learning models generated in accordance with the present disclosure may be utilized to process data and make decisions in connection with banking, education, manufacturing or retail applications, or any other applications, in accordance with the present disclosure. Moreover, those of ordinary skill in the pertinent arts will recognize that any of the aspects of embodiments disclosed herein may be utilized with or applicable to any other aspects of any of the other embodiments disclosed herein.

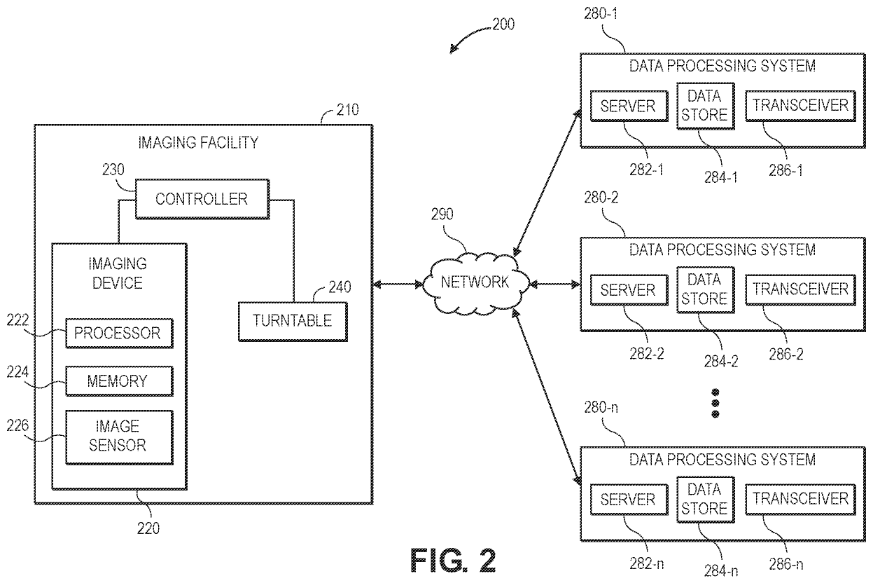

Referring to FIG. 2, a block diagram of one system 200 for synthesizing images from 3D models in accordance with embodiments of the present disclosure is shown. As is shown in FIG. 2, the system 200 includes an imaging facility 210 and a plurality of data processing systems 280-1, 280-2 . . . 280-n that are connected to one another over a network 290, which may include the Internet in whole or in part. Except where otherwise noted, reference numerals preceded by the number “2” shown in the block diagram of FIG. 2 indicate components or features that are similar to components or features having reference numerals preceded by the number “1” shown in FIGS. 1A through 1D.

As is further shown in FIG. 2, the imaging facility 210 includes an imaging device 220, a controller 230, and a turntable 240. The imaging device 220 further includes a processor 222, a memory component 224 (e.g., a data store) and image sensors 226.

The imaging device 220 may comprise any form of optical recording sensor or device that may be used to photograph or otherwise record information or data (e.g., still or moving images captured at any frame rates) regarding activities occurring within one or more areas or regions of an environment within the imaging facility 210, e.g., the turntable 240 and any objects provided thereon, or for any other purpose. For example, the imaging device 220 may be configured to capture one or more still or moving images, along with any relevant audio signals or other information, and may also connect to or otherwise communicate with the data processing systems 280-1, 280-2 . . . 280-n or with one or more other external computer devices over the network 290, through the sending and receiving of digital data.

The imaging device 220 further includes one or more processors 222 and memory components 224 and any other components (not shown) that may be required in order to capture, analyze and/or store imaging data. For example, the imaging device 220 may capture one or more still or moving images (e.g., streams of visual and/or depth image frames), along with any relevant audio signals or other information (e.g., position data), and may also connect to or otherwise communicate with the data processing systems 280-1, 280-2 . . . 280-n, or any other computer devices over the network 290, through the sending and receiving of digital data. In some embodiments, the imaging device 220 may be configured to communicate through one or more wired or wireless means, e.g., wired technologies such as Universal Serial Bus (or “USB”) or fiber optic cable, or standard wireless protocols such as Bluetooth® or any Wireless Fidelity (or “Wi-Fi”) protocol. The processors 222 may be configured to process imaging data captured by one or more of the image sensors 226. For example, in some embodiments, the processors 222 may be configured to execute any type or form of machine learning tools or techniques.

The image sensors 226 may be any sensors, such as color sensors, grayscale sensors, black-and-white sensors, or other visual sensors, as well as depth sensors or any other type of sensors, that are configured to capture visual imaging data (e.g., textures) or depth imaging data (e.g., ranges) to objects within one or more fields of view of the imaging device 220. In some embodiments, the image sensors 226 may have single elements or a plurality of photoreceptors or photosensitive components (e.g., a CCD sensor, a CMOS sensor, or another sensor), which may be typically arranged in an array. Light reflected from objects within fields of view of the imaging device 220 may be captured by the image sensors 226 and quantitative values, e.g., pixels, may be assigned to one or more aspects of the reflected light.

Additionally, the imaging device 220 may have any number of image sensors 226 in accordance with the present disclosure. For example, the imaging device 220 may be an RGBz or RGBD device having both a color sensor and a depth sensor. Alternatively, one or more imaging devices 220 may be provided within the imaging facility 210, each having either a color sensor or a depth sensor, or both a color sensor and a depth sensor.

In addition to the one or more processors 222, the memory components 224 and the image sensors 226, the imaging device 220 may also include any number of other components that may be required in order to capture, analyze and/or store imaging data, including but not limited to one or more lenses, memory or storage components, photosensitive surfaces, filters, chips, electrodes, clocks, boards, timers, power sources, connectors or any other relevant features (not shown). Additionally, in some embodiments, each of the image sensors 226 may be provided on a substrate (e.g., a circuit board) and/or in association with a stabilization module having one or more springs or other systems for compensating for motion of the imaging device 220, or any vibration affecting the image sensors 226.

The imaging device 220 may also include manual or automatic features for modifying their respective fields of view or orientations. For example, one or more of the imaging device 220 may be configured in a fixed position, or with a fixed focal length (e.g., fixed-focus lenses) or angular orientation. Alternatively, the imaging device 220 may include one or more motorized features for adjusting a position of the imaging device, or for adjusting either the focal length (e.g., zooming the imaging device) or the angular orientation (e.g., the roll angle, the pitch angle or the yaw angle), by causing changes in the distance between the sensor and the lens (e.g., optical zoom lenses or digital zoom lenses), changes in the location of the imaging device 220, or changes in one or more of the angles defining the angular orientation.

For example, the imaging device 220 may be hard-mounted to a support or mounting that maintains the device in a fixed configuration or angle with respect to one, two or three axes. Alternatively, however, the imaging device 220 may be provided with one or more motors and/or controllers for manually or automatically operating one or more of the components, or for reorienting the axis or direction of the device, i.e., by panning or tilting the device. Panning an imaging device may cause a rotation within a horizontal axis or about a vertical axis (e.g., a yaw), while tilting an imaging device may cause a rotation within a vertical plane or about a horizontal axis (e.g., a pitch). Additionally, an imaging device may be rolled, or rotated about its axis of rotation, and within a plane that is perpendicular to the axis of rotation and substantially parallel to a field of view of the device.

In some embodiments, the imaging device 220 may also digitally or electronically adjust an image captured from a field of view, subject to one or more physical and operational constraints. For example, a digital camera may virtually stretch or condense the pixels of an image in order to focus or broaden a field of view of the digital camera, and also translate one or more portions of images within the field of view. Imaging devices having optically adjustable focal lengths or axes of orientation are commonly referred to as pan-tilt-zoom (or “PTZ”) imaging devices, while imaging devices having digitally or electronically adjustable zooming or translating features are commonly referred to as electronic PTZ (or “ePTZ”) imaging devices.

Information and/or data regarding features or objects expressed in imaging data, including colors, textures, outlines or other aspects of the features or objects, may be extracted from the data in any number of ways. For example, colors of image pixels, or of groups of image pixels, in a digital image may be determined and quantified according to one or more standards, e.g., the RGB color model, in which the portions of red, green or blue in an image pixel are expressed in three corresponding numbers ranging from 0 to 255 in value, or a hexadecimal model, in which a color of an image pixel is expressed in a six-character code, wherein each of the characters may have a range of sixteen. Colors may also be expressed according to a six-character hexadecimal model, or #NNNNNN, where each of the characters N has a range of sixteen digits (i.e., the numbers 0 through 9 and letters A through F). The first two characters NN of the hexadecimal model refer to the portion of red contained in the color, while the second two characters NN refer to the portion of green contained in the color, and the third two characters NN refer to the portion of blue contained in the color. For example, the colors white and black are expressed according to the hexadecimal model as #FFFFFF and #000000, respectively, while the color National Flag Blue is expressed as #3C3B6E. Any means or model for quantifying a color or color schema within an image or photograph may be utilized in accordance with the present disclosure. Moreover, textures or features of objects expressed in a digital image may be identified using one or more computer-based methods, such as by identifying changes in intensities within regions or sectors of the image, or by defining areas of an image corresponding to specific surfaces.

Furthermore, edges, contours, outlines, colors, textures, silhouettes, shapes or other characteristics of objects, or portions of objects, expressed in still or moving digital images may be identified using one or more algorithms or machine-learning tools. The objects or portions of objects may be stationary or in motion, and may be identified at single, finite periods of time, or over one or more periods or durations. Such algorithms or tools may be directed to recognizing and marking transitions (e.g., the edges, contours, outlines, colors, textures, silhouettes, shapes or other characteristics of objects or portions thereof) within the digital images as closely as possible, and in a manner that minimizes noise and disruptions, and does not create false transitions. Some detection algorithms or techniques that may be utilized in order to recognize characteristics of objects or portions thereof in digital images in accordance with the present disclosure include, but are not limited to, Canny edge detectors or algorithms; Sobel operators, algorithms or filters; Kayyali operators; Roberts edge detection algorithms; Prewitt operators; Frei-Chen methods; or any other algorithms or techniques that may be known to those of ordinary skill in the pertinent arts. For example, objects or portions thereof expressed within imaging data may be associated with a label or labels (e.g., an annotation or annotations) according to one or more machine-learning classifiers, algorithms or techniques, including but not limited to nearest neighbor methods or analyses, artificial neural networks, factorization methods or techniques, K-means clustering analyses or techniques, similarity measures such as log likelihood similarities or cosine similarities, latent Dirichlet allocations or other topic models, or latent semantic analyses.

The controller 230 may be any computer-based control system configured to control the operation of the imaging device 220 and/or the turntable 240. The controller 230 may include one or more computer processors, computer displays and/or data stores, or one or more other physical or virtual computer device or machines (e.g., an encoder for synchronizing operations of the imaging device 220 and the turntable 240). The controller 230 may also be configured to transmit, process or store any type of information to one or more external computer devices or servers over the network 290. For example, in some embodiments, the controller 230 may cause the turntable 240 to rotate at a selected angular velocity, e.g., with one or more objects provided thereon, and may further cause the imaging device 220 to capture images with the turntable and any objects thereon within a field of view, e.g., at any frame rate.

The turntable (or carousel) 240 may be any form of moving or rotating machine that may accommodate an item thereon, and may cause the item to rotate at a fixed or variable angular velocity. The turntable 240 may include a substantially flat disk or other feature having a surface for accommodating and supporting items thereon, and maintaining the items in place, as well as one or more shafts, motors or other features for causing the disk to rotate with the items thereon within a common, preferably horizontal plane. The operation of the motors or other features may be controlled by the controller 230, which may include one or more relays, timers or other features for initiating the rotation of the disk and for establishing an angular velocity thereof. The turntable 240 may optionally further include one or more skid-resistant features, e.g., high-friction surfaces formed from materials such as plastics or rubbers, for maintaining one or more items thereon, or may be formed from one or more such materials.

The data processing systems 280-1, 280-2 . . . 280-n may be an artificial intelligence engine or any other system that includes one or more physical or virtual computer servers 282-1, 282-2 . . . 282-n or other computer devices or machines having any number of processors that may be provided for any specific or general purpose, and one or more data stores (e.g., data bases) 284-1, 284-2 . . . 284-n and transceivers 286-1, 286-2 . . . 286-n associated therewith. For example, the data processing systems 280-1, 280-2 . . . 280-n of FIG. 2 may be independently provided for the exclusive purpose of receiving, analyzing, processing or storing data captured by the imaging facility 210, e.g., the imaging device 220, or, alternatively, provided in connection with one or more physical or virtual services that are configured to receive, analyze or store such data, or perform any other functions. The data stores 284-1, 284-2 . . . 284-n may store any type of information or data, including but not limited to imaging data, acoustic signals, or any other information or data, for any purpose. The servers 282-1, 282-2 . . . 282-n and/or the data stores 284-1, 284-2 . . . 284-n may also connect to or otherwise communicate with the network 290, through the sending and receiving of digital data.

The data processing systems 280-1, 280-2 . . . 280-n may further include any facility, structure, or station for receiving, analyzing, processing or storing data using the servers 282-1, 282-2 . . . 282-n, the data stores 284-1, 284-2 . . . 284-n and/or the transceivers 286-1, 286-2 . . . 286-n. For example, the data processing systems 280-1, 280-2 . . . 280-n may be provided within or as a part of one or more independent or freestanding facilities, structures, stations or locations that need not be associated with any one specific application or purpose. In some embodiments, the data processing systems 280-1, 280-2 . . . 280-n may be provided in a physical location. In other such embodiments, the data processing systems 280-1, 280-2 . . . 280-n may be provided in one or more alternate or virtual locations, e.g., in a “cloud”-based environment.

The servers 282-1, 282-2 . . . 282-n are configured to execute any calculations or functions for training, validating or testing one or more machine learning models, or for using such machine learning models to arrive at one or more decisions or results. In some embodiments, the servers 282-1, 282-2 . . . 282-n may be a uniprocessor system including one processor, or a multiprocessor system including several processors (e.g., two, four, eight, or another suitable number), and may be capable of executing instructions. For example, in some embodiments, the servers 282-1, 282-2 . . . 282-n may include one or more general-purpose or embedded processors implementing any of a number of instruction set architectures (ISAs), such as the x86, PowerPC, SPARC, or MIPS ISAs, or any other suitable ISA. Where one or more of the servers 282-1, 282-2 . . . 282-n is a multiprocessor system, each of the processors within the multiprocessor system may operate the same ISA, or different ISAs.

The servers 282-1, 282-2 . . . 282-n may be configured to generate and train, validate or test any type or form of machine learning model, or to utilize any type or form of machine learning model, in accordance with the present disclosure. Some of the machine learning models that may be generated or operated in accordance with the present disclosure include, but are not limited to, artificial neural networks (e.g., convolutional neural networks, or recurrent neural networks), deep learning systems, support vector machines, nearest neighbor methods or analyses, factorization methods or techniques, K-means clustering analyses or techniques, similarity measures such as log likelihood similarities or cosine similarities, latent Dirichlet allocations or other topic models, or latent semantic analyses. The types or forms of machine learning models that may be generated or operated by the servers 282-1, 282-2 . . . 282-n or any other computer devices or machines disclosed herein are not limited.

In some embodiments, one or more of the servers 282-1, 282-2 . . . 282-n may be configured to generate a 3D model of an object based on data captured by or in association with the object. For example, in some embodiments, one or more of the servers 282-1, 282-2 . . . 282-n may be configured to generate a 3D model from depth data, e.g., data maintained in an .OBJ file format, or in any other format, as well as from visual images, e.g., data maintained in a .JPG file format, or material data, e.g., data maintained in an .MTL file format, or depth, visual or material data maintained in any other format. The servers 282-1, 282-2 . . . 282-n may be configured to generate 3D models in the form of textured meshes (or polygon meshes) defined by sets of points in three-dimensional space, which may be obtained from depth data (or a depth model), by mapping or patching portions or sectors of visual images to polygons defined by the respective points of the depth data. In some embodiments, one or more of the servers 282-1, 282-2 . . . 282-n may be configured to generate a 3D model according to one or more photogrammetry techniques, one or more videogrammetry techniques, or one or more panoramic stitching techniques, or according to any other techniques.

In some embodiments, the servers 282-1, 282-2 . . . 282-n may be configured to modify a 3D model of an object on any basis prior to synthetically generating 2D visual images of the object using the 3D model. In some embodiments, the servers 282-1, 282-2 . . . 282-n may modify one or more aspects of the depth data from which a 3D model is generated, in order to generate 3D models of an object having different sizes, shapes or other attributes, such as to generate a 3D model that is larger, smaller, more stout or more slender than the object, or features one or more eccentricities as compared to the object. The servers 282-1, 282-2 . . . 282-n may select variations in the depth data, or in the resulting dimensions of 3D models generated based on the depth data, on any basis. Furthermore, in some embodiments, the servers 282-1, 282-2 . . . 282-n may modify one or more aspects of the visual data from which a 3D model is generated, in order to generate 3D models of an object that have different appearances from the object, such as to generate a 3D model having different textures, colors, reflectances or other properties than the object.

Moreover, in some embodiments, the servers 282-1, 282-2 . . . 282-n may select one or more orientations of a 3D model of an object in order to cause the 3D model to appear differently from a given perspective, e.g., at any angle or position along or about any axis, thus enabling 2D visual images of the object to be synthesized from the 3D model in the various orientations. In some embodiments, the orientations or angles about which the 3D model is rotated or repositioned may be calculated or otherwise determined on any basis, e.g., according to one or more quaternions or other number systems. In some embodiments, the servers 282-1, 282-2 . . . 282-n may further augment or otherwise modify 2D visual images generated from a 3D model of an object to cause the object to appear in one or more contexts or scenarios, e.g., in a visual context or scenario that is consistent with an anticipated or intended use of the object. Subsequently, the servers 282-1, 282-2 . . . 282-n may utilize the 2D visual images depicting the object in such contexts or scenarios to generate or train a machine learning model to recognize the object in such contexts or scenarios.

The data stores 284-1, 284-2 . . . 284-n (or other memory or storage components) may store any type of information or data, e.g., instructions for operating the data processing systems 280-1, 280-2 . . . 280-n, or information or data received, analyzed, processed or stored by the data processing systems 280-1, 280-2 . . . 280-n. The data stores 284-1, 284-2 . . . 284-n may be implemented using any suitable memory technology, such as static random-access memory (SRAM), synchronous dynamic RAM (SDRAM), nonvolatile/Flash-type memory, or any other type of memory. In some embodiments, program instructions, imaging data and/or other data items may be received or sent via a transceiver, e.g., by transmission media or signals, such as electrical, electromagnetic, or digital signals, which may be conveyed via a communication medium such as a wired and/or a wireless link.

In some embodiments, the data stores 284-1, 284-2 . . . 284-n may include one or more sources of information or data of any type or form, and such data may, but need not, have been captured using the imaging device 220. For example, the data stores 284-1, 284-2 . . . 284-n may include any source or repository of data, e.g., an open source of data, that may be accessed by one or more computer devices or machines via the network 290, including but not limited to the imaging device 220. For example, such sources of information or data may be associated with a library, a laboratory, a government agency, an educational institution, or an industry or trade group, and may include any number of associated computer devices or machines for receiving, analyzing, processing and/or storing information or data thereon.

The transceivers 286-1, 286-2 . . . 286-n are configured to enable the data processing systems 280-1, 280-2 . . . 280-n to communicate through one or more wired or wireless means, e.g., wired technologies such as Ethernet, USB or fiber optic cable, or standard wireless protocols such as Bluetooth® or any Wi-Fi protocol, such as over the network 290 or directly. Such transceivers 286-1, 286-2 . . . 286-n may further include or be in communication with one or more input/output (or “I/O”) interfaces, network interfaces and/or input/output devices, and may be configured to allow information or data to be exchanged between one or more of the components of the data processing systems 280-1, 280-2 . . . 280-n, or to one or more other computer devices or systems (e.g., the imaging device 220 or others, not shown) via the network 290. For example, in some embodiments, a transceiver 286-1, 286-2 . . . 286-n may be configured to coordinate I/O traffic between the servers 282-1, 282-2 . . . 282-n and/or data stores 284-1, 284-2 . . . 284-n or one or more internal or external computer devices or components. Such transceivers 286-1, 286-2 . . . 286-n may perform any necessary protocol, timing or other data transformations in order to convert data signals from a first format suitable for use by one component into a second format suitable for use by another component. In some other embodiments, functions ordinarily performed by the transceivers 286-1, 286-2 . . . 286-n may be split into two or more separate components, or integrated with the servers 282-1, 282-2 . . . 282-n and/or the data stores 284-1, 284-2 . . . 284-n.

Although FIG. 2 shows just a single box corresponding to an imaging facility 210, and three boxes corresponding to data processing systems 280-1, 280-2 . . . 280-n, those of ordinary skill in the pertinent arts will recognize that the system 200 shown in FIG. 2 may include any number of imaging facilities 210 or data processing systems 280-1, 280-2 . . . 280-n, or that functions performed by the imaging facility 210 or the data processing systems 280-1, 280-2 . . . 280-n may be performed in a single facility, or in two or more distributed facilities, in accordance with the present disclosure.

The network 290 may be any wired network, wireless network, or combination thereof, and may comprise the Internet in whole or in part. In addition, the network 290 may be a personal area network, local area network, wide area network, cable network, satellite network, cellular telephone network, or combination thereof. The network 290 may also be a publicly accessible network of linked networks, possibly operated by various distinct parties, such as the Internet. In some embodiments, the network 290 may be a private or semi-private network, such as a corporate or university intranet. The network 290 may include one or more wireless networks, such as a Global System for Mobile Communications (GSM) network, a Code Division Multiple Access (CDMA) network, a Long-Term Evolution (LTE) network, or some other type of wireless network. Protocols and components for communicating via the Internet or any of the other aforementioned types of communication networks are well known to those skilled in the art of computer communications and thus, need not be described in more detail herein.

The computers, servers, devices and the like described herein have the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. Also, those of ordinary skill in the pertinent art will recognize that users of such computers, servers, devices and the like may operate a keyboard, keypad, mouse, stylus, touch screen, or other device (not shown) or method to interact with the computers, servers, devices and the like, or to “select” an item, link, node, hub or any other aspect of the present disclosure.

Any of the functions described herein as being executed or performed by the data processing systems 280-1, 280-2 . . . 280-n, or any other computer devices or systems (not shown in FIG. 2), may be executed or performed by the processor 222 of the imaging device 220, or any other computer devices or systems (not shown in FIG. 2), in accordance with embodiments of the present disclosure. Likewise, any of the functions described herein as being executed or performed by the processor 222 or the imaging device 220, or any other computer devices or systems (not shown in FIG. 2), may be executed or performed by the data processing systems 280-1, 280-2 . . . 280-n, or any other computer devices or systems (not shown in FIG. 2), in accordance with embodiments of the present disclosure.

The imaging facility 210, the imaging device 220, the controller 230 or the data processing systems 280-1, 280-2 . . . 280-n may use any web-enabled or Internet applications or features, or any other client-server applications or features including E-mail or other messaging techniques, to connect to the network 290, or to communicate with one another. For example, the imaging facility 210, the imaging device 220, the controller 230 or the data processing systems 280-1, 280-2 . . . 280-n may be adapted to transmit information or data in the form of synchronous or asynchronous messages between one another, or to any other computer device or system, in real time or in near-real time, or in one or more offline processes, via the network 290. Those of ordinary skill in the pertinent art would recognize that the imaging facility 210, the imaging device 220, the controller 230 or the data processing systems 280-1, 280-2 . . . 280-n may operate, include or be associated with any of a number of computing devices that are capable of communicating over the network 290, including but not limited to personal digital assistants, digital media players, laptop computers, desktop computers, tablet computers, smartphones, electronic book readers, and the like. The protocols and components for providing communication between such devices are well known to those skilled in the art of computer communications and need not be described in more detail herein.

The data and/or computer executable instructions, programs, firmware, software and the like (also referred to herein as “computer executable” components) described herein may be stored on a computer-readable medium that is within or accessible by computers or computer components such as the imaging facility 210, the imaging device 220, the controller 230 or the data processing systems 280-1, 280-2 . . . 280-n, or any other computers or control systems utilized by the imaging facility 210, the imaging device 220, the controller 230 or the data processing systems 280-1, 280-2 . . . 280-n, and having sequences of instructions which, when executed by a processor (e.g., a central processing unit, or “CPU”), cause the processor to perform all or a portion of the functions, services and/or methods described herein. Such computer executable instructions, programs, software, and the like may be loaded into the memory of one or more computers using a drive mechanism associated with the computer readable medium, such as a floppy drive, CD-ROM drive, DVD-ROM drive, network interface, or the like, or via external connections.

Some embodiments of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, or other types of media/machine-readable medium that may be suitable for storing electronic instructions. Further, embodiments may also be provided as a computer executable program product that includes a transitory machine-readable signal (in compressed or uncompressed form). Examples of machine-readable signals, whether modulated using a carrier or not, may include, but are not limited to, signals that a computer system or machine hosting or running a computer program can be configured to access, or including signals that may be downloaded through the Internet or other networks.

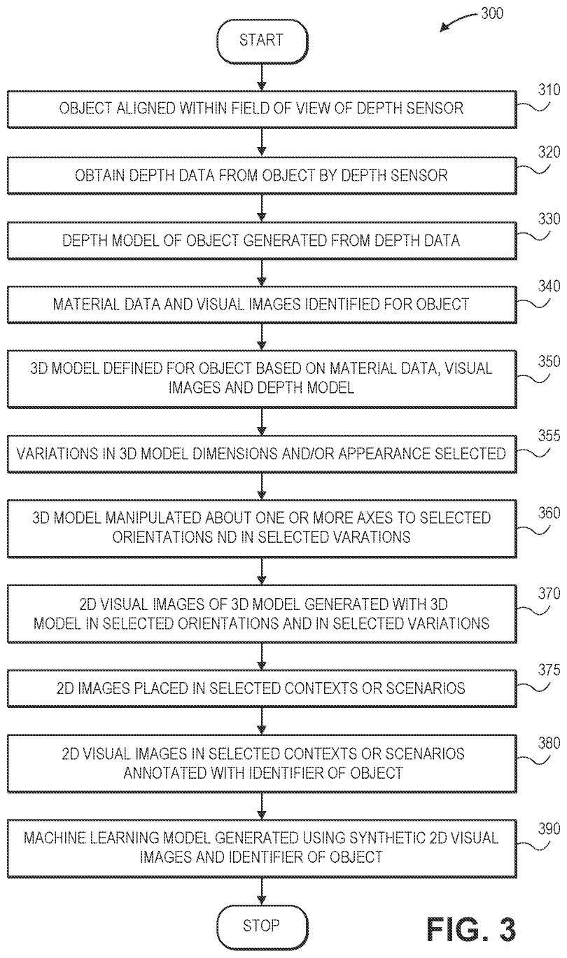

Referring to FIG. 3, a flow chart 300 of one process for synthesizing images from 3D models in accordance with embodiments of the present disclosure is shown. At box 310, an object is aligned within a field of view of a depth sensor. The object may be any type or form of consumer product, manufactured good, living entity (e.g., one or more body parts of a human or non-human animal), inanimate article, or any other thing of any size. The depth sensor may comprise one or more components of an imaging device that is configured to capture depth imaging data, such as a range camera, independently or along with imaging data of any other type or form, such as visual imaging data (e.g., color or grayscale images). Alternatively, in some embodiments, the depth sensor may be a laser ranging system, a LIDAR sensor, or any other systems, and the object may be aligned within an operating range of one or more of such systems. The object and the depth sensor may be configured to rotate or otherwise be repositioned with respect to one another, such as by placing the object on a turntable that may be independently controlled to rotate or be repositioned about an axis or in any other manner.

At box 320, depth data is obtained from the object by the depth sensor. The depth data may be captured at any intervals of time, and with the object in various orientations or positions. In some embodiments, the depth data is obtained with the object in motion (e.g., rotational or translational motion) and the depth sensor fixed in orientation and position. In some embodiments, the depth data is obtained with the object fixed in orientation and position, and the depth sensor in motion (e.g., rotational or translational motion). In some embodiments, the depth data is obtained with each of the object and the depth sensor in motion (e.g., rotational or translational motion). Additionally, the depth sensor may capture depth images or other depth data at frame rates of thirty frames per second (30 fps), or at any other frame rate, and at any level of resolution. Alternatively, in some embodiments, where the depth sensor is a laser ranging system, the depth data may be obtained at any suitable measurement rate. In some other embodiments, depth data may be derived from one or more two-dimensional (or 2D) images of the object, such as by modeling the object using stereo or structure-from-motion (or SFM) algorithms.

At box 330, a depth model is generated based at least in part on the depth data obtained at box 320. The depth model may be a point cloud, a depth map or another representation or reconstruction of surfaces of the object generated based on the various depth data samples (e.g., depth images) obtained at box 320, such as a set of points that may be described with respect to Cartesian coordinates, or in a photogrammetric manner, or in any other manner, and stored in one or more data stores. For example, in some embodiments, the depth model may be generated by tessellating the depth data into sets of polygons (e.g., triangles) corresponding to vertices or edges of surfaces of the object. In some embodiments, the depth data may be stored in one or more data stores or memory components, for example, in an .OBJ file format, or in any other format.

At box 340, material data and visual images are identified for the object. For example, the material data may include one or more sets of data or metadata corresponding to measures or indicators of textures, colors, reflectances or other properties of the respective surfaces of the object. In some embodiments, the depth data may be stored in one or more data stores or memory components, for example, in an .MTL file format, or in any other format. The visual images may be captured from the object at the same time as the depth data at box 320, e.g., by an imaging device that also includes the depth sensor or another imaging device, or prior or subsequent to the capture of the depth data. In some embodiments, the visual images may be stored in one or more data stores or memory components, for example, in a .JPG file format, or in any other format.

At box 350, one or more 3D models are defined for the object based on the material data, the visual images and the depth model. For example, the 3D models may be textured meshes (or polygon meshes) defined by sets of points in three-dimensional space, which may be obtained from the depth model of the object generated at box 330, e.g., by mapping or patching portions or sectors of the visual images to polygons defined by the respective points of the depth model. The 3D models may be defined at the same time that the depth model is generated, e.g., in real time or in near-real time, to the extent that the material data and the visual images are available for the object, or at a later time.

At box 355, one or more variations in the dimensions and/or appearance of the 3D models are selected. As is discussed above, aspects of the 3D models defined at box 350 may be varied in order to increase a number of potential images that may be generated based on the 3D models. For example, in some embodiments, positions of one or more of points of a textured mesh (or polygon mesh) or another 3D model may be varied in order to change a size or a shape of the 3D model, e.g., to vary one or more dimensions of the 3D model, such as to enlarge or shrink the 3D model, or to distort or alter one or more aspects or other features of the 3D model, or of 2D images captured thereof. Similarly, in some embodiments, textures, colors, reflectances or other properties of surfaces of one or more surfaces (or polygons) of a textured mesh or another 3D model may be varied to change an appearance of the 3D model, or to alter one or more aspects or other features of the 3D model, or of 2D images captured thereof. Any other variations in dimensions or an appearance of a 3D model may be selected on any basis in accordance with embodiments of the present disclosure.

At box 360, the 3D models are manipulated about one or more axes to place the 3D models in any number of selected orientations and in accordance with the selected variations in dimensions or appearance, e.g., in an interface rendered on a video display. For example, as is shown in FIG. 1D, the 3D models may be virtually manipulated to cause the 3D models to appear differently from a given vantage point, e.g., by rotating or translating the 3D models about or along one or more axes. In some embodiments, the 3D models may be rotated by any angular intervals, e.g., by forty-five degrees (45°), by ten degrees (10°), by one degree (1°), by one-tenth of one degree (0.1°), by one-hundredth of one degree (0.01°), or by any other intervals, and about any axes, in order to place the 3D models in a desired orientation.

At box 370, one or more 2D visual images are generated with the 3D models in the selected orientations and in the selected variations. The 2D visual images may be generated in any manner, such as by a screen capture, an in-game camera, or any other manner of capturing an image of at least a portion of an interface displayed on a video display.

At box 375, the 2D visual images are modified to depict the object in one or more selected contexts or scenarios. For example, in some embodiments, the 2D visual images generated based on the 3D models of the objects may be applied to or alongside one or more other visual images, e.g., as background or foreground images, such as by pasting, layering, transforming, or executing any other functions with respect to the visual images. For example, where 2D visual images are generated from a 3D model of an automobile part, the 2D visual images may be applied in combination with images of automobiles, tools, packaging, or other objects to depict the automobile part in a manner consistent with its anticipated or intended use. Similarly, where 2D visual images are generated from a 3D model of a food product, the 2D visual images may be applied in combination with images of one or more storage facilities, bowls, refrigerators, or other objects to depict the food product in a manner consistent with its anticipated or intended use. In some embodiments, any number (e.g., all, some, or none) of the 2D visual images generated at box 370 may be subjected to or modified to depict the object in any number of contexts or scenarios. For example, in some embodiments, the 3D models may be depicted within 2D visual images that are transparent or background-free, or without any other colors or textures other than those of the 3D models depicted therein.

At box 380, the 2D visual images in the selected contexts or scenarios are annotated with one or more identifiers of the object. For example, in some embodiments, the identifiers (e.g., a label) of the object may be stored in association with each of the 2D visual images in a record or other file. In some other embodiments, each of the 2D visual images may be automatically annotated, e.g., by pixel-wise segmentation, to identify locations of the depicted 3D models within the 2D visual images. For example, in some embodiments, an image or other representation of the 2D visual images may be generated in a binary or other fashion, such that locations corresponding to aspects of the depicted 3D models are shown as white or black, and locations not corresponding to the depicted 3D models are shown as black or white, respectively, or another pair of contrasting colors. Alternatively, or additionally, in some embodiments, a virtual marking such as a box, an outline, or another shape may be applied to each of the 2D visual images, indicating that the 2D visual images depict the object, e.g., in a location of the box, the outline or the other shape within the 2D visual images. Further, in some embodiments, the 2D visual images that are annotated need not be depicted in any contexts or scenarios.

At box 390, a machine learning model is generated using the synthetic 2D visual images and the identifiers of the object in the selected contexts or scenarios, and the process ends. For example, the 2D visual images may be split into a training set, a validation set and a test set, along with annotations of the object. A substantially large portion of the synthetic 2D visual images may be used for training the machine learning model, e.g., in some embodiments, approximately seventy to eighty percent of the images, and smaller portions of the synthetic 2D visual images may be used for testing and validation, e.g., in some embodiments, approximately ten percent of the images each for testing and validation of the machine learning model. The sizes of the respective sets of data for training, for validation and for testing may be chosen on any basis. Moreover, in some embodiments, the 2D visual images that are used to generate the machine learning model need not be depicted in any contexts or scenarios, and may instead merely depict the 3D models of the object, without any other colors or textures.

The machine learning model may be of any type or form, and may be trained for the performance of one or more applications, tasks or functions associated with recognizing the object, including but not limited to computer vision, object recognition, anomaly detection, outlier detection or any other tasks. For example, in some embodiments, the machine learning model may be an artificial neural network, a deep learning system, a support vector machine, a nearest neighbor method or analysis, a factorization method or technique, a K-means clustering analysis or technique, a similarity measure such as a log likelihood similarity or cosine similarity, a latent Dirichlet allocation or other topic model, a decision tree, or a latent semantic analysis, or any other machine learning model. The number of applications, tasks or functions that may be performed by a machine learning model trained at least in part using one or more synthetic 2D visual images in accordance with the present disclosure is not limited.

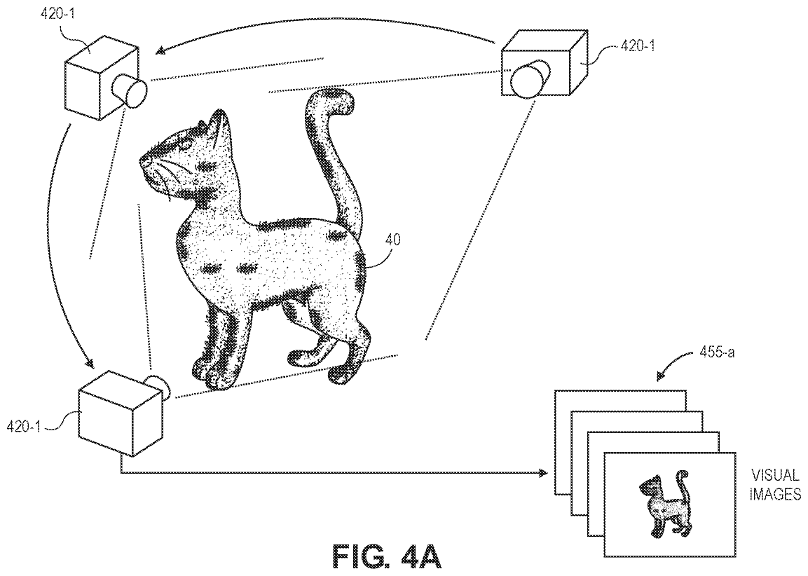

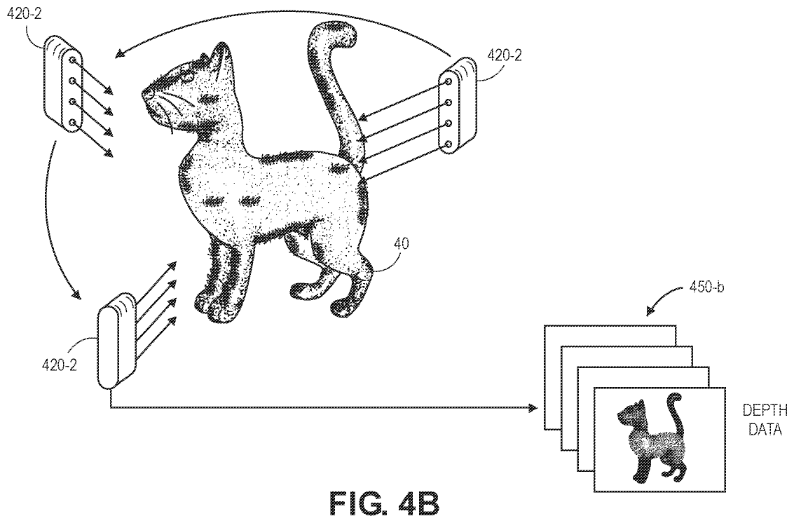

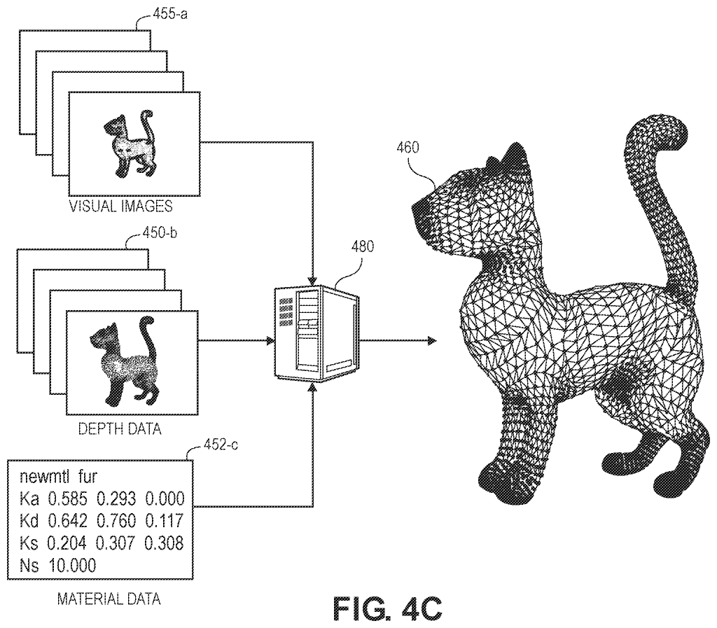

As is discussed above, 3D models of objects may be generated based on visual images, depth data (or depth models generated therefrom) and material data regarding the objects. Referring to FIGS. 4A through 4C, views of aspects of one system for synthesizing images from 3D models in accordance with embodiments of the present disclosure is shown. Except where otherwise noted, reference numerals preceded by the number “4” shown in FIGS. 4A through 4C indicate components or features that are similar to components or features having reference numerals preceded by the number “2” shown in FIG. 2 or by the number “1” shown in FIGS. 1A through 1D.

As is shown in FIG. 4A, a digital camera 420-1 is rotated about an object 40 (e.g., an animal, such as a cat). A plurality of visual images 455-a are captured with the digital camera 420-1 in various orientations or alignments with respect to the object 40, e.g., with the digital camera 420-1 rotating or translating along or about one or more axes with respect to the object 40. Alternatively, in some embodiments, the object 40 may be rotated or translated with respect to the digital camera 420-1, e.g., by placing the object 40 on a turntable or other system and fixing the position and orientation of the digital camera 420-1, as the visual images 455-a are captured.

Similarly, as is shown in FIG. 4B, a laser scanner 420-2 is also rotated about the object 40. A plurality of depth data 450-b is captured with the laser scanner 420-2 in various orientations or alignments with respect to the object 40, e.g., with the laser scanner 420-2 rotating or translating along or about one or more axes with respect to the object 40. Alternatively, in some embodiments, the object 40 may be rotated or translated with respect to the laser scanner 420-2 as the depth data 450-b is captured. In some embodiments, the visual images 455-a may be files or records in .JPG file format, or other like formats, while the depth data 450-b may be files or records in .OBJ file format, or other like formats, and the material data 452-c may be files or records in .MTL file format, or other like formats.

As is shown in FIG. 4C, a 3D model 460 of the object 40 is generated based at least in part on the visual images 455-a, the depth data 450-b and material data 452-c regarding the object 40, which may include but need not be limited to one or more measures or indicators of textures, colors, reflectances or other properties of surfaces of the object 40. For example, in some embodiments, the depth data 450-b may be tessellated, such that triangles or other polygons are formed from a point cloud or other representation of the depth data 450-b by extending line segments between pairs of points corresponding to surfaces of the object 40, and portions of the visual images 455-a are patched or otherwise applied onto such polygons in order to generate the 3D model 460. Alternatively, the 3D model 460 may be generated in any other manner, based at least in part on the visual images 455-a, the depth data 450-b and material data 452-c. The visual images 455-a, the depth data 450-b, and the material data 452-c may be provided to a server or other computer device or system to generate the 3D model 460.

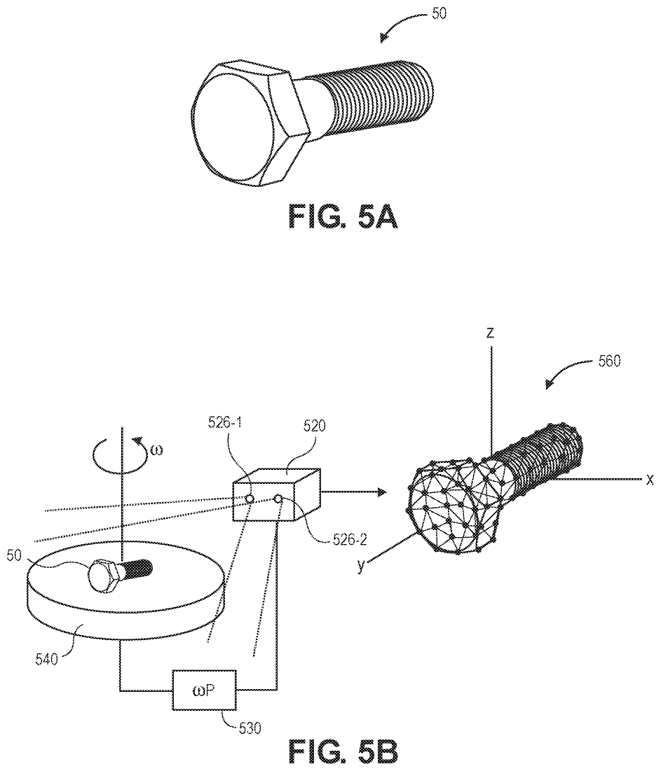

In some embodiments, a 3D model of an object may be generated by one or more processors provided aboard an imaging device or other system configured to capture visual imaging data and/or depth data regarding the object. Referring to FIGS. 5A and 5B, views of aspects of one system for synthesizing images from 3D models in accordance with embodiments of the present disclosure is shown. Except where otherwise noted, reference numerals preceded by the number “5” shown in FIGS. 5A through 5B indicate components or features that are similar to components or features having reference numerals preceded by the number “4” shown in FIGS. 4A through 4C, by the number “2” shown in FIG. 2 or by the number “1” shown in FIGS. 1A through 1D.

As is shown in FIG. 5A, an object 50 is a bolt or other article of hardware for fastening two or more objects to one another. As is shown in FIG. 5B, the object 50 is placed upon a turntable 540 or other rotatable system within a field of view of an imaging device 520 including a visual sensor 526-1 (e.g., a color, grayscale or black-and-white visual sensor) and a depth sensor 526-2 (e.g., one or more infrared light sources and/or time-of-flight systems, or any other sensors). The imaging device 520 and the turntable 540 may be operated under the control of a control system 530 having one or more processors. The control system 530 may cause the turntable 540 to rotate at a selected angular velocity ω, within the field of view of the imaging device 520, and cause the imaging device 520 to capture visual imaging data (e.g., visual images) and depth imaging data (e.g., depth data) regarding the object 50. Based on the visual imaging data and the depth imaging data, a 3D model 560 of the object 50 may be generated, such as by tessellating a point cloud or other representation of the surfaces of the object 50, and applying portions of the visual imaging data to triangles or other polygons formed by the tessellation. The 3D model 560 may be generated in any manner, such as according to one or more photogrammetry techniques, one or more videogrammetry techniques, or one or more panoramic stitching techniques, or any other techniques.

Subsequently, the 3D model 560 may be displayed on a user interface shown on a video display and virtually manipulated, e.g., by rotating or translating the 3D model 560 about or along one or more axes, to any linear or angular extent. With the 3D model 560 in any number of orientations or alignments, 2D visual images may be captured or otherwise synthetically generated based on the 3D model 560, e.g., by a screen capture or in-game camera capture. The synthetic 2D visual images may be annotated with one or more identifiers of the object 50, and used to train, validate and/or test a machine learning model to recognize or detect the object 50 within imaging data. Alternatively, one or more dimensions of the 3D model 560, or aspects of the appearance of the 3D model 560, may be varied in any manner, such as by modifying a size or shape of the 3D model 560, or one or more textures, colors, reflectances or other properties of surfaces of the 3D model 560, and placing the modified 3D model 560 in any number of orientations or alignments to enable 2D visual images to be captured or otherwise synthetically generated based on the 3D model 560 with the varied dimensions or appearances, and in the various orientations or alignments.

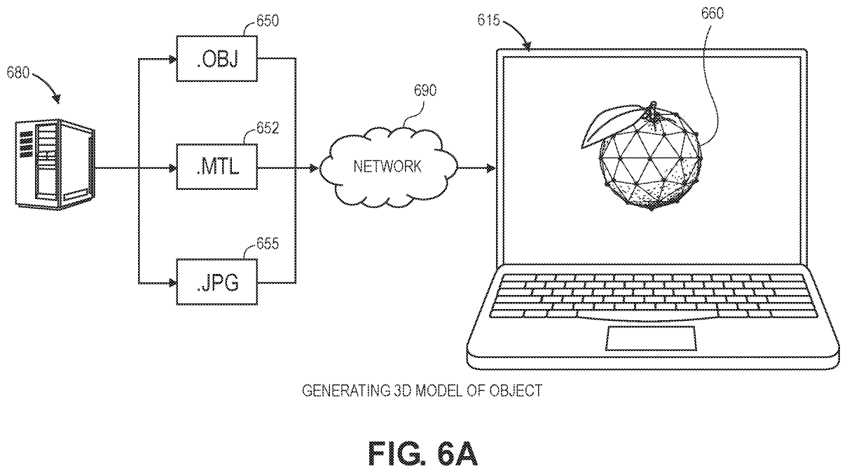

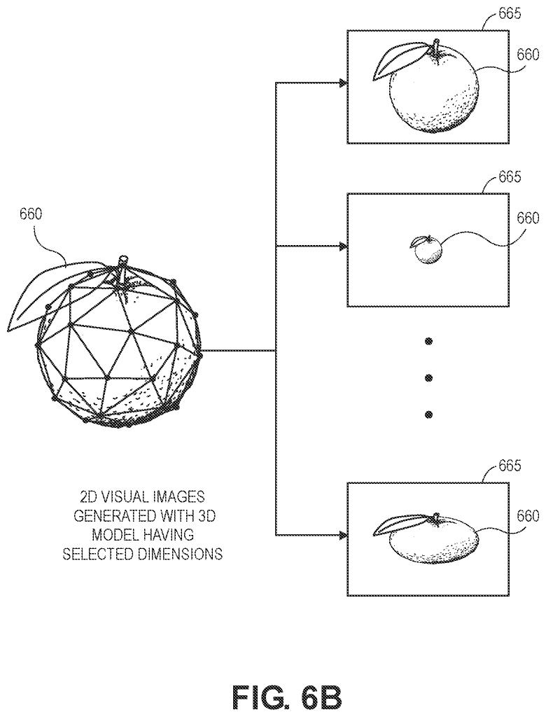

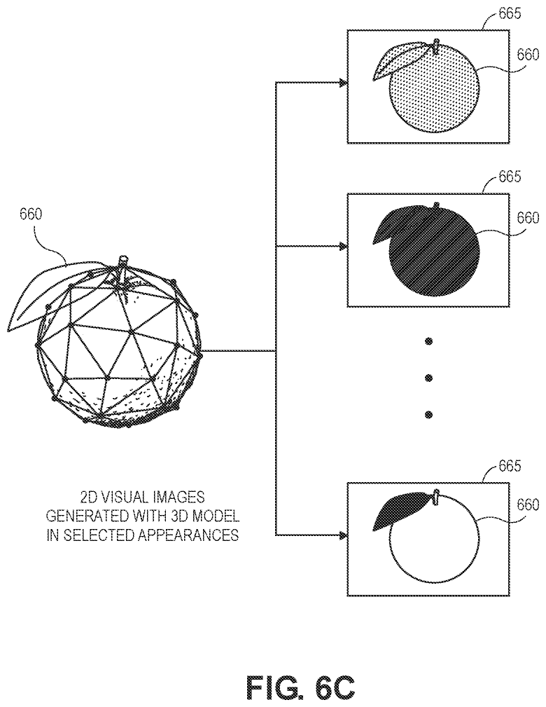

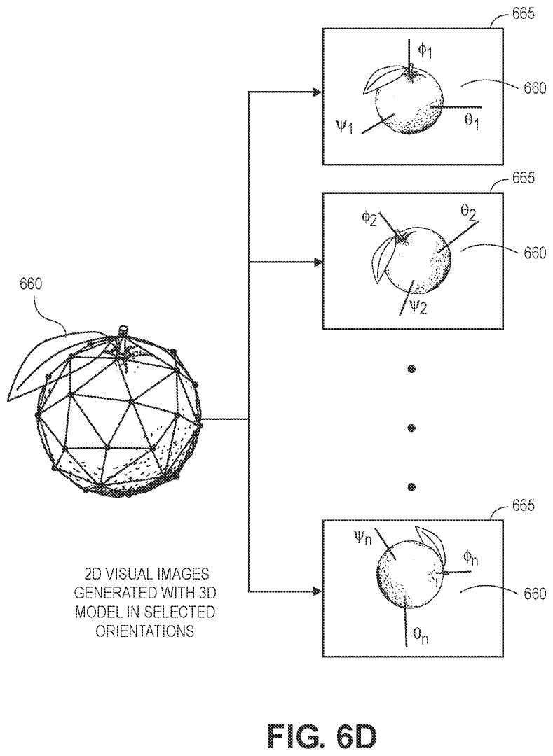

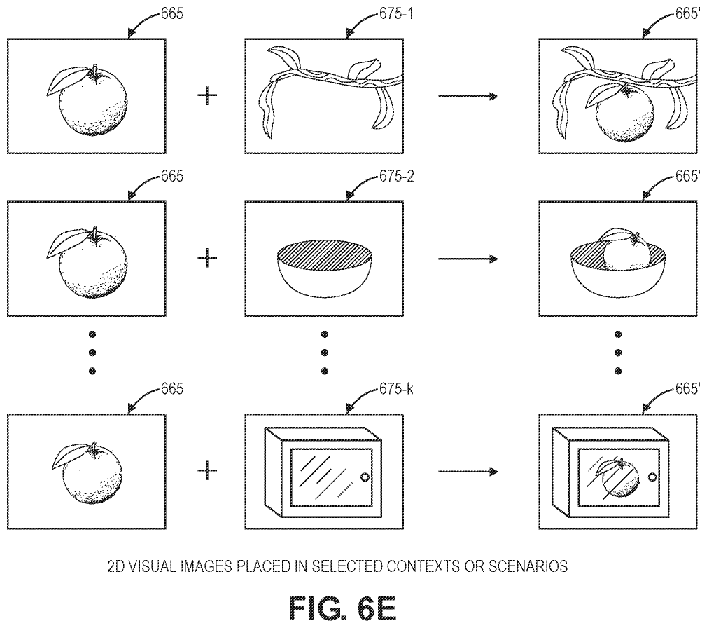

As is discussed above, a 3D model of an object may be virtually manipulated on a video display to cause the 3D model to appear in any number of orientations or alignments, and 2D visual images may be generated from the 3D model accordingly. Referring to FIGS. 6A through 6E, views of aspects of one system for synthesizing images from 3D models in accordance with embodiments of the present disclosure is shown. Except where otherwise noted, reference numerals preceded by the number “6” shown in FIGS. 6A through 6E indicate components or features that are similar to components or features having reference numerals preceded by the number “5” shown in FIGS. 5A through 5B, by the number “4” shown in FIGS. 4A through 4C, by the number “2” shown in FIG. 2 or by the number “1” shown in FIGS. 1A through 1D.

As is shown in FIG. 6A, a server 680 may transfer depth data 650, material data 652 and visual imaging data 655 of an object (viz., an orange) to a computer 615 over a network 690. The depth data 650, the material data 652 and the visual imaging data 655 may have been captured or generated in any manner in accordance with embodiments of the present disclosure, e.g., by one or more imaging devices or other components. The computer 615 is configured to generate and render a 3D model 660 of the object on a display.

As is discussed above, 2D visual images may be generated based on the 3D model 660 as generated from the depth data 650, the material data 652 or the visual imaging data 655, and such 2D visual images may form all or portions of a data set that may be used to generate or train and test or validate a machine learning model to recognize the object. Alternatively, one or more aspects of the 3D model 660 may be varied, e.g., dimensions or aspects of the appearance of the 3D model 660, and 2D visual images may be generated from the 3D model 660 with such varied dimensions or appearances, thereby increasing an available number of 2D visual images within the data set. As is shown in FIG. 6B, 2D visual images 665 may be generated from the 3D model 660 with variations in dimensions, e.g., sizes or shapes. For example, as is shown in FIG. 6B, positions of one or more portions of surfaces of the 3D model 660 may be repositioned or otherwise modified to cause the 3D model 660 to appear larger or smaller, or in various shapes, within the 2D visual images 665. Corresponding portions of visual images that are applied to such surfaces may be adjusted in size or shape accordingly.

Similarly, as is shown in FIG. 6C, 2D visual images 665 may generated with aspects of the appearance of the 3D model 660 subject to one or more variations. For example, as is shown in FIG. 6C, textures, colors, reflectances or other properties of surfaces of the 3D model 660 may be varied to enable 2D visual images 665 depicting the object with such textures, colors, reflectances or other properties to be synthetically generated.

As is shown in FIG. 6D, the 3D model 660 of the object may be virtually manipulated to cause the 3D model 660 to appear in any number of orientations or alignments, and one or more 2D visual images 665 may be synthesized from the 3D model 660 in any of the orientations or alignments. For example, as is shown in FIG. 6D, 2D visual images 665 may be generated, e.g., by screen capture, an in-game camera, or a rendering engine, or in any other manner, with the 3D model 660 shown as being oriented or aligned at an angle ϕ₁, an angle θ₁ and an angle ω₁, respectively, about three axes. Likewise, 2D visual images 665 may be generated with the 3D model 660 shown as being oriented or aligned at an angle ϕ₂, an angle θ₂ and an angle ω₂, respectively, about the three axes. Any number n of 2D visual images 665 may be generated with the 3D model 660 shown as being oriented or aligned at angles ϕₙ, angles θₙ and angles ωₙ, respectively, about the three axes. Each of the 2D visual images 665 may be annotated with one or more identifiers of the object, and used to train, validate or test a machine learning model in one or more recognition or detection applications in accordance with embodiments of the present disclosure.

As is shown in FIG. 6E, any of the 2D visual images 665 of the object that are synthetically generated using the 3D model 660 may be augmented or otherwise modified to depict the object in any number of contexts or scenarios. For example, as is shown in FIG. 6E, a set of modified 2D visual images 665′ may be generated by placing 2D visual images 665 generated based on the 3D model 660 in visual contexts or scenarios 675-1, 675-2 . . . 675-k that are consistent with an anticipated or intended use of the object. Thus, one or more of the modified 2D visual images 665′ of the set may be used to generate or train a machine learning model to recognize the object within such visual contexts or scenarios, among others, or to test or validate the machine learning model.

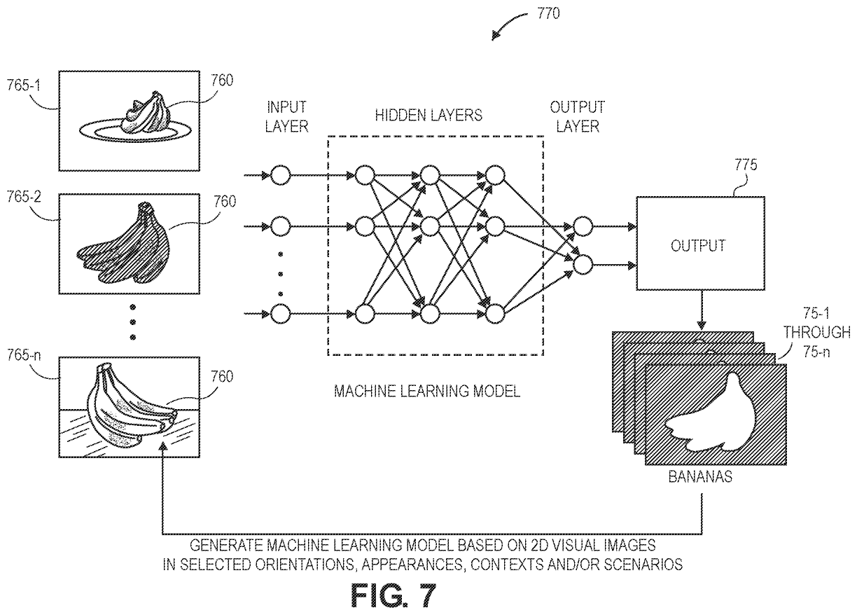

Referring to FIG. 7, views of aspects of one system for synthesizing images from 3D models in accordance with embodiments of the present disclosure is shown. Except where otherwise noted, reference numerals preceded by the number “7” shown in FIG. 7 indicate components or features that are similar to components or features having reference numerals preceded by the number “6” shown in FIGS. 6A through 6E, by the number “5” shown in FIGS. 5A through 5B, by the number “4” shown in FIGS. 4A through 4C, by the number “2” shown in FIG. 2 or by the number “1” shown in FIGS. 1A through 1D.

As is shown in FIG. 7, a plurality of 2D visual images 765-1, 765-2 . . . 765-n of an object that are synthetically generated from a 3D model 760 of the object are shown. The 2D visual images 765-1, 765-2 . . . 765-n depict the 3D model 760 with various dimensions or appearances, and in different orientations, visual contexts or scenarios. The 2D visual images 765-1, 765-2 . . . 765-n are provided as inputs to a machine learning model 770, which may be any artificial neural network, deep learning system, support vector machine, nearest neighbor methods or analyses, factorization methods or technique, K-means clustering analyses or technique, similarity measures such as log likelihood similarities or cosine similarities, latent Dirichlet allocations or other topic model, decision tree, or latent semantic analyses. Additionally, outputs 775 generated by the machine learning model 770, e.g., a feedforward neural network or a recurrent neural network, are compared to annotations 75-1 through 75-n of the object that are associated with each of the 2D visual images 765-1, 765-2 . . . 765-n. One or more parameters regarding strengths or weights of connections between neurons in the various layers of the machine learning model 770 may be adjusted accordingly, as necessary, until the outputs 775 are most closely approximated or associated with the inputs, e.g., until the outputs 775 most closely match the annotations 75-1 through 75-n, to the maximum practicable extent.

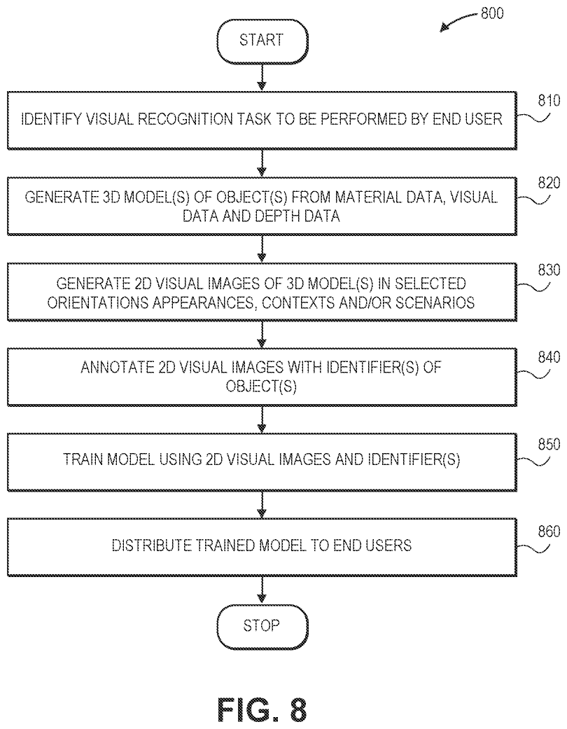

Referring to FIG. 8, a flow chart 800 of one process for synthesizing images from 3D models in accordance with embodiments of the present disclosure is shown. At box 810, a task requiring the visual recognition of a task to be performed by an end user is identified. The task may be any number of computer-based tasks such as computer vision, object recognition or anomaly detection that are to be performed by or on behalf of the end user, or one or more other end users.

At box 820, one or more 3D models of objects are generated from material data, visual data and/or depth data captured or otherwise obtained from the objects. For example, the material data may identify measures or indicators of textures, colors, reflectances or other properties of surfaces of the objects, and may be stored in one or more files or records (e.g., .MTL files) associated with the objects. Likewise, the visual data may include one or more visual images (e.g., .JPG files) of the objects from one or more vantage points or perspectives. The depth data may be one or more depth images or other sets of data, or a point cloud or depth model generated based on such images or data (e.g., .OBJ files). The depth data may have been captured or otherwise obtained from the objects at the same time as the material data or the visual images, e.g., in real time or in near-real time, or, alternatively, at any other time. The material data, the visual data and/or the depth data may have been captured with the 3D models of the objects in any number of orientations, such as where one or more sensors (e.g., imaging devices) and the objects are in rotational and/or translational motion with respect to one another.

At box 830, 2D visual images of the objects are synthetically generated with the 3D models in one or more selected orientations, appearances, contexts and/or scenarios, e.g., in an interface rendered on a video display. For example, each of the 3D models may be manipulated, e.g., by rotating or translating the 3D model about or along one or more axes, such as by any desired angular intervals. Any number of the 2D visual images may be synthetically generated with a 3D model of an object in any position or orientation, or with the 3D model having any visual variations in dimensions or appearances, in accordance with the present disclosure. Any number of the 2D visual images may also be synthetically generated with the 3D model of an object in any contexts or scenarios in accordance with the present disclosure.

At box 840, the 2D visual images are annotated with identifiers of the objects associated with their respective 3D models. For example, identifiers such as labels may be stored in association with the 2D visual images or in any other manner, e.g., in a record or file, along with any other information, data or metadata regarding the objects or the 2D visual images, including but not limited to coordinates or other identifiers of locations within the respective 2D visual images corresponding to the objects. In some embodiments, the 2D visual images may be manually or automatically annotated, e.g., by pixel-wise segmentation of the 2D visual images, or in any other manner.

At box 850, a machine learning model is trained using the 2D visual images and their identifiers or other annotations. For example, any number of the 2D visual images may be provided to the machine learning model as inputs, and outputs received from the machine learning model may be compared to the identifiers or other annotations of the corresponding 2D visual images. In some embodiments, whether the machine learning model is sufficiently trained may be determined based on a difference between outputs generated in response to the inputs and the identifiers or other annotations. Likewise, the machine learning model may be tested or validated using any number of the 2D visual images and their identifiers or other annotations.

At box 860, the trained model is distributed to one or more end users, and the process ends. For example, code or other data for operating the machine learning model, such as one or more matrices of weights or other attributes of layers or neurons of an artificial neural network, may be transmitted to computer devices or systems associated with the end users over one or more networks. Additionally, the machine learning model may be refined or updated in a similar manner, e.g., by further training, to the extent that additional material data, visual images and/or depth data is available regarding one or more of the objects, or any other objects.

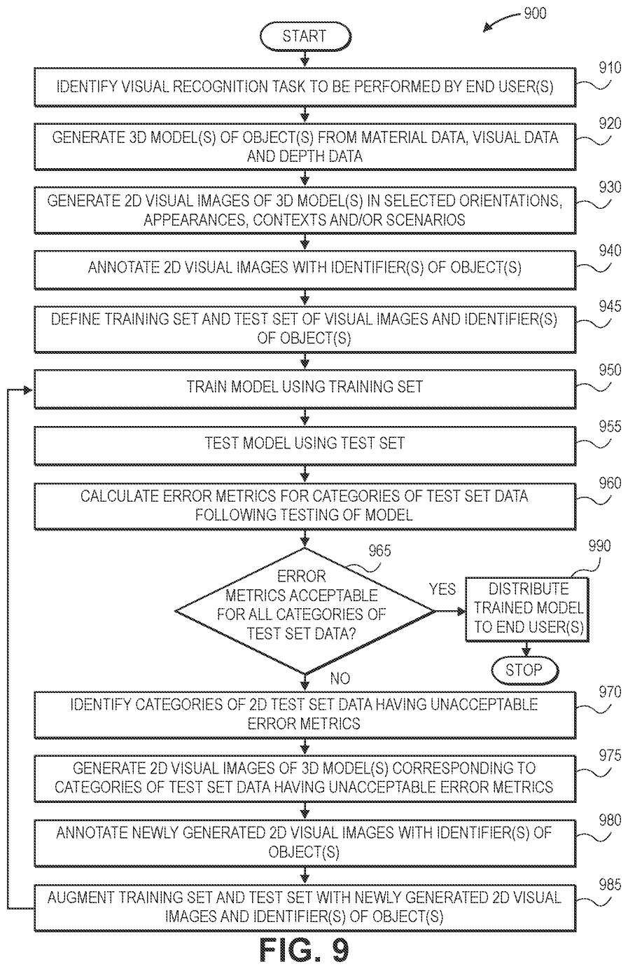

Referring to FIG. 9, a flow chart 900 of one process for synthesizing images from 3D models in accordance with embodiments of the present disclosure is shown. At box 910, a task requiring the visual recognition of one or more objects that is to be performed by an end user is identified. The task may be any number of computer-based tasks such as computer vision, object recognition or anomaly detection that are to be performed by or on behalf of the end user, or one or more other end users. In some embodiments, multiple tasks requiring the visual recognition of the objects that are to be performed by the end user, or one or more other end users, may be identified.

At box 920, one or more 3D models of the objects are generated from material data, visual data and/or depth data captured or otherwise obtained from the objects. For example, the material data may identify measures or indicators of textures, colors, reflectances or other properties of surfaces of the objects, and may be stored in one or more files or records (e.g., .MTL files) associated with the objects. Likewise, the visual data may include one or more visual images (e.g., .JPG files) of the objects from one or more vantage points or perspectives. The depth data may be one or more depth images or other sets of data, or a point cloud or depth model generated based on such images or data (e.g., .OBJ files). The depth data may have been captured or otherwise obtained from the object at the same time as the material data or the visual images, e.g., in real time or in near-real time, or, alternatively, at any other time. The material data, the visual data and/or the depth data may have been captured with the 3D models of the objects in any number of orientations, such as where one or more sensors (e.g., imaging devices) and the object are in rotational and/or translational motion with respect to one another.

At box 930, 2D visual images of the objects are synthetically generated with the 3D models in one or more selected orientations, appearances, contexts and/or scenarios, e.g., in an interface rendered on a video display. For example, each of the 3D models may be manipulated, e.g., by rotating or translating the 3D model about or along one or more axes, such as by any desired angular intervals. Any number of the 2D visual images may be synthetically generated with a 3D model of an object in any position or orientation, or with the 3D model having any visual variations in dimensions or appearances, in accordance with the present disclosure. Any number of the 2D visual images may also be synthetically generated with the 3D model of an object in any contexts or scenarios in accordance with the present disclosure.

At box 940, each of the 2D visual images is annotated with an identifier of the object associated with their respective 3D models. For example, identifiers such as labels may be stored in association with the 2D visual images or in any other manner, e.g., in a record or file, along with any other information, data or metadata regarding the object or the 2D visual images, including but not limited to coordinates or other identifiers of locations within the respective 2D visual images corresponding to the object. In some embodiments, the 2D visual images may be manually or automatically annotated, e.g., by pixel-wise segmentation of the 2D visual images, or in any other manner.

At box 945, a training set and a test set are defined from the 2D visual images and the identifier(s) of the object(s) depicted therein. In some embodiments, a substantially larger portion of the 2D visual images and corresponding annotations of identifiers, e.g., seventy to eighty percent of the images and identifiers, may be combined into a training set of data, and a smaller portion of the 2D visual images and corresponding annotations of identifiers may be combined into a test set of data. Alternatively, or additionally, a validation set of the 2D visual images and the identifiers may be defined, along with the training set and the test set. The 2D visual images and identifiers that are assigned to the training set, the test set and, alternatively, a validation set may be selected at random or on any other basis. For example, in some embodiments, the training set may include images that depict the 3D models of the objects without any additional contexts or scenarios, and without any additional coloring or texturing.

The respective 2D visual images of the training set and the test set, and their corresponding identifiers, may be classified as residing in or being parts of one or more categories (or subsets or regimes). For example, subsets of the 2D visual images may be classified based on the orientations or views of the 3D models depicted therein (e.g., top view, bottom view, side view, or other views, as well as angles or alignments of one or more perspectives of the 3D models depicted within the 2D visual images). Likewise, other subsets of the 2D visual images may be classified into categories (or subsets or regimes) based on lighting or illumination conditions on the 3D models at times at which the 2D visual images were generated, additional coloring or textures applied to the 3D models prior to the generation of the 2D visual images, or contexts or scenarios in which the 3D models were depicted when the 2D visual images were generated. Alternatively, or additionally, the 2D visual images of the training set or the test set may be classified as residing in or being parts of any other categories (or subsets or regimes).

At box 950, a machine learning model is trained using the training set defined at box 945. For example, any number of the 2D visual images of the training set may be provided to the machine learning model as inputs, and outputs received from the machine learning model may be compared to the identifiers or other annotations of the corresponding 2D visual images. In some embodiments, whether the machine learning model is sufficiently trained, or is ready for testing, may be determined based on differences between outputs generated in response to the inputs and the identifiers or other annotations. At box 955, the machine learning model is tested using the test set defined at box 945. For example, the machine learning model may be tested by providing the 2D visual images of the test set to the machine learning model as inputs, and comparing outputs generated in response to such inputs to the identifiers or other annotations.

At box 960, error metrics are calculated for categories of the test set data following the testing of the machine learning model at box 955. For example, for each of such categories, the effectiveness of the machine learning model in recognizing an object in a 2D visual image of the 3D model and an identifier with which the 2D visual image is annotated may be calculated for each of the categories (or subsets or regimes) of the test set data. Any type or form of error metric, and any number of such error metrics, may be calculated for the categories of the test set data in accordance with embodiments of the present disclosure, including but not limited to a mean square error (or root mean square error), a mean absolute error, a mean percent error, a correlation coefficient, a coefficient of determination, or any other error metrics. Moreover, the error metrics may represent actual or relative error values that are calculated at any scale or on any basis.

At box 965, whether the error metrics are acceptable for all categories (or subsets or regimes) of the test set data is determined. If the error metrics are not acceptable, e.g., within a predetermined range or below a predetermined threshold, for one or more of the categories of the test set data, then the process advances to box 970, where categories of the 2D test set data having unacceptable error metrics are identified.

At box 975, 2D visual images of the objects are synthetically generated with the 3D models in one or more selected orientations, appearances, contexts and/or scenarios corresponding to the categories identified at box 970. Any number of the 2D visual images in such categories may be synthetically generated with the 3D models of the objects in any positions or orientations, or with orientations, appearances, contexts and/or scenarios corresponding to the categories identified at box 970 in accordance with the present disclosure. By synthetically generating additional 2D visual images that correspond only to the categories having unacceptable error metrics, the relevance of the 2D visual images is enhanced, and the amount of additional data generated is limited.

At box 980, each of the 2D visual images that is generated at box 975 is annotated with an identifier of the object associated with their respective 3D models. The newly generated 2D visual images may be manually or automatically annotated, e.g., by pixel-wise segmentation of the 2D visual images, or in any other manner. At box 985, the training set and the test set are augmented by the 2D visual images that were newly generated at box 975 and the corresponding identifiers of such objects with which the 2D visual images were annotated at box 980. The training set and the test set may be augmented with the newly generated 2D visual images and their corresponding identifiers in any manner and on any basis. For example, a larger portion of the newly generated 2D visual images and their identifiers, e.g., seventy to eighty percent, may be added to the training set, and a smaller portion of the newly generated 2D visual images and their identifiers, e.g., ten to twenty percent, may be added to the test set. Alternatively, or additionally, a validation set may be defined from the newly generated 2D visual images and their corresponding identifiers, or a previously defined validation set may be augmented by one or more of the newly generated 2D visual images and their corresponding identifiers. The 2D visual images and identifiers that are assigned to the training set, the test set and, alternatively, a validation set may be selected at random or on any other basis.

After the training set and the test set have been augmented by the 2D visual images that were newly generated at box 975 and the corresponding identifiers of such objects with which the 2D visual images were annotated at box 980, the process returns to box 950, where the model is trained using the training set, as augmented, and to box 955, where the trained model is tested using the test set, as augmented. In some embodiments, additional 2D visual images of the 3D models may be generated in any number of iterations, as necessary, in each of the categories for which error metrics remain unacceptable, e.g., outside of a predetermined range or above a predetermined threshold, for any number of the iterations.

However, if the error metrics are acceptable, e.g., within a predetermined range or below a predetermined threshold, for each of the categories of the test set data, then the process advances to box 990, where the trained model is distributed to the one or more end users for the performance of the visual recognition task, and the process ends. For example, code or other data for operating the machine learning model, such as one or more matrices of weights or other attributes of layers or neurons of an artificial neural network, may be transmitted to computer devices or systems associated with the end users over one or more networks.

Although the disclosure has been described herein using exemplary techniques, components, and/or processes for implementing the systems and methods of the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure.

For example, although some of the embodiments disclosed herein reference the generation of artificial intelligence solutions, including the generation, training, validation, testing and use of machine learning models, in applications such as computer vision applications, object recognition applications, and anomaly detection applications, those of ordinary skill in the pertinent arts will recognize that the systems and methods disclosed herein are not so limited. Rather, the artificial intelligence solutions and machine learning models disclosed herein may be utilized in connection with the performance of any task or in connection with any type of application, e.g., sounds or natural language processing, having any industrial, commercial, recreational or other use or purpose.

It should be understood that, unless otherwise explicitly or implicitly indicated herein, any of the features, characteristics, alternatives or modifications described regarding a particular embodiment herein may also be applied, used, or incorporated with any other embodiment described herein, and that the drawings and detailed description of the present disclosure are intended to cover all modifications, equivalents and alternatives to the various embodiments as defined by the appended claims. Moreover, with respect to the one or more methods or processes of the present disclosure described herein, including but not limited to the processes represented in the flow charts of FIG. 3, 8 or 9, orders in which such methods or processes are presented are not intended to be construed as any limitation on the claimed inventions, and any number of the method or process steps or boxes described herein can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain embodiments could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to a stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative embodiments thereof, the foregoing and various other additions and omissions may be made therein and thereto without departing from the spirit and scope of the present disclosure.

What is claimed is:

1. A system comprising:
a turntable configured to rotate a substantially flat surface about a first axis;
an imaging device comprising a visual image sensor and a depth image sensor, wherein the turntable is within at least one field of view of the imaging device; and
a server in communication with the imaging device,
wherein the server is programmed with one or more sets of instructions that, when executed by the server, cause the server to execute a method comprising:
receiving, from the imaging device, a first set of visual images of an object resting on top of the substantially flat surface, wherein each of the visual images of the first set is captured with the turntable rotating about the first axis, and wherein at least two of the visual images of the first set are captured with the object in different positions with respect to the first axis;
receiving, from the imaging device, a first set of depth data regarding the object, wherein the first set of depth data is captured with the turntable rotating about the first axis;
generating a first three-dimensional model of the object based at least in part on the first set of visual images and the first set of depth data;
selecting a first plurality of orientations for the first three-dimensional model;
rendering the first three-dimensional model in at least some of the first plurality of orientations;
generating a second set of visual images of the first three-dimensional model, wherein each of the visual images of the second set is generated with the first three-dimensional model rendered in one of the first plurality of orientations; and
training a machine learning model to recognize the object based at least in part on at least some of the second set of the visual images and an identifier of the object.

2. The system of claim 1, wherein the method further comprises:
generating a point cloud corresponding to at least a portion of at least one surface of the object, wherein the point cloud is generated based at least in part on at least some of the first set of depth data;
tessellating the point cloud; and
applying at least a portion of at least some of the first set of visual images to the tessellated point cloud,
wherein the first three-dimensional model is the tessellated point cloud having at least the portion of the at least some of the first set of visual images applied thereto.

3. The system of claim 1, wherein the machine learning model is at least one of:
an artificial neural network, a deep learning system, a support vector machine, a nearest neighbor analysis, a factorization method, a K-means clustering technique, a similarity measure, a latent Dirichlet allocation, a decision tree or a latent semantic analysis.

4. The system of claim 1, wherein the method further comprises:
modifying at least a portion of at least one of the first set of visual images or the first set of depth data;
generating a second three-dimensional model of the object based at least in part on the modified portion of the at least one of the first set of visual images or the first set of depth data;
selecting a second plurality of orientations for the second three-dimensional model;
rendering the second three-dimensional model in at least some of the second plurality of orientations; and
generating a third set of visual images of the second three-dimensional model, wherein each of the visual images of the third set is generated with the second three-dimensional model rendered in one of the second plurality of orientations,
wherein the machine learning model is trained to recognize the object based at least in part on the at least some of the second set of the visual images, at least some of the third set of visual images, and the identifier of the object.

5. The system of claim 1, wherein each of the second set of visual images is in one of a plurality of categories,
wherein each of the categories relates to one of:
an orientation of the first three-dimensional model when one of the second set of visual images was generated;
a lighting condition of the first three-dimensional model when the one of the second set of visual images was generated;
a color of the first three-dimensional model when the one of the second set of visual images was generated; or
a texture of the first three-dimensional model when the one of the second set of visual images was generated, and
wherein the method further comprises:
splitting the second set of the visual images into a first subset and a second subset, and wherein training the machine learning model to recognize the object based at least in part on at least some of the second set of the visual images and the identifier comprises:
training the machine learning model to perform a computer-based task based at least in part on the first subset and the identifier of the object; and
testing the machine learning model based at least in part on the second subset and the identifier of the object, wherein testing the machine learning model comprises:
providing each of the second subset of the second set of visual images to the machine learning model as inputs; and
receiving outputs from the machine learning model in response to the inputs,
wherein each of the outputs is received in response to one of the inputs;
calculating at least one error metric for each of the categories of the second subset of the second set of visual images based at least in part on a difference between:
the identifier of the object; and
the output received from the machine learning model in response to an input comprising one of the second set of visual images;
determining that error metrics calculated for the second subset of the second set of visual images in one of the categories exceed a threshold;
in response to determining that the error metrics calculated for the second subset of the second set of visual images in the one of the categories exceed the threshold,
generating a third set of visual images of the first three-dimensional model, wherein each of the visual images of the third set is generated with the first three-dimensional model in accordance with the one of the categories; and
training the machine learning model to perform the computer-based task based at least in part on at least a portion of the third set of visual images and the identifier of the object.

6. A computer-implemented method comprising:
generating a first three-dimensional model of an object based at least in part on:
a first set of visual images, wherein each of the first set of visual images depicts the object in one of a first plurality of orientations; and
a first set of depth data, wherein the set of depth data defines at least one surface of the object;
generating a second set of visual images based at least in part on the first three-dimensional model, wherein each of the second set of visual images depicts the first three-dimensional model rendered in one of a second plurality of orientations; and
training a machine learning model to perform a task associated with the object based at least in part on at least some of the second set of visual images and at least one identifier of the object.

7. The computer-implemented method of claim 6, wherein generating the second set of visual images comprises:
causing a display of at least a portion of the first three-dimensional model rendered in each of the second plurality of orientations in at least one user interface on a display; and
capturing visual images of the at least one user interface on the display, wherein each of the visual images is captured with at least the portion of the first three-dimensional model rendered in one of the second plurality of orientations in the at least one user interface, and
wherein each of the second set of visual images is one of the visual images captured with at least the portion of the first three-dimensional model rendered in one of the second plurality of orientations in the at least one user interface.

8. The computer-implemented method of claim 6, wherein training the machine learning model to perform the task associated with the object comprises:
providing the at least some of the second set of visual images to the machine learning model as inputs;
receiving outputs from the machine learning model in response to the inputs; and
comparing the outputs to the at least one identifier of the object.

9. The computer-implemented method of claim 6, wherein each of the first set of visual images is captured by an imaging device comprising a visual image sensor, and
wherein each of the first set of visual images is captured with the imaging device and the object in relative rotational or translational motion with respect to one another.

10. The computer-implemented method of claim 6, wherein generating the first three-dimensional model comprises:
generating a point cloud corresponding to at least a portion of the object based at least in part on the set of depth data;
tessellating the point cloud; and
patching at least a portion of at least some of the first set of visual images onto the tessellated point cloud.

11. The computer-implemented method of claim 6, wherein training the machine learning model to perform the task comprises:
annotating each of the second set of visual images with the identifier of the object;
parsing the second set of visual images into at least a training subset and a testing subset;
training the machine learning model to perform the task based at least in part on the training subset, and
testing the machine learning model based at least in part on the testing subset.

12. The computer-implemented method of claim 11, further comprising:
calculating at least one error metric for at least some of the images of the testing subset, wherein the at least one error metric is calculated based at least in part on a difference between the identifier of the object and an output received from the machine learning model in response to an input comprising one of the images of the testing subset;
determining that error metrics calculated for images of the testing subset in a category of images exceed a predetermined threshold, wherein the category is one of:
an orientation of the first three-dimensional model when one of the images of the testing subset was generated;
a lighting condition of the first three-dimensional model when the one of the images of the testing subset was generated;
a color of the first three-dimensional model when the one of the images of the testing subset was generated; or
a texture of the first three-dimensional model when the one of the images of the testing subset was generated;
in response to determining that the error metrics for the images in the testing subset in the category of images exceed the predetermined threshold,
generating at least one image based at least in part on the first three-dimensional model, wherein the at least one image is in the category of images; and
training the machine learning model to perform the task associated with the object based at least in part on the at least one image and the at least one identifier of the object.

13. The computer-implemented method of claim 6, further comprising:
transmitting code for operating the machine learning model to at least one computer device over at least one network.

14. The computer-implemented method of claim 6, wherein the task comprises:
recognizing the object in at least one visual image; or
determining an anomaly with the object based at least in part on the at least one visual image.

15. The computer-implemented method of claim 6, further comprising:
generating a second three-dimensional model based at least in part on the first three-dimensional model, wherein at least one of a dimension, a color or a texture of the second three-dimensional model is different from the at least one of the dimension, the color or the texture of the first three-dimensional model; and
generating a third set of visual images based at least in part on the second three-dimensional model, wherein each of the third set of visual images depicts the second three-dimensional model rendered in one of a third plurality of orientations,
wherein the machine learning model is trained to perform the task associated with the object based at least in part on the at least some of the second set of visual images, at least some of the third set of visual images and the at least one identifier of the object.

16. The computer-implemented method of claim 6, wherein the machine learning model is an artificial neural network comprising an input layer having a first plurality of neurons, at least one hidden layer having at least a second plurality of neurons, and an output layer having a third plurality of neurons,
wherein a first connection between at least one of the first plurality of neurons and at least one of the second plurality of neurons in the machine learning model has a first synaptic weight,
wherein a second connection between at least one of the second plurality of neurons and at least one of the third plurality of neurons in the machine learning model has a second synaptic weight, and
wherein training the machine learning model to perform the task comprises:
selecting at least one of the first synaptic weight for the first connection or the second synaptic weight for the second connection based at least in part on at least one of the second set of visual images and the identifier of the object.

17. The computer-implemented method of claim 6, wherein the machine learning model is at least one of an artificial neural network, a deep learning system, a support vector machine, a nearest neighbor analysis, a factorization method, a K-means clustering technique, a similarity measure, a latent Dirichlet allocation, a decision tree or a latent semantic analysis.

18. A computer-implemented method comprising:
causing relative rotation of an object with respect to an imaging device configured to capture visual images and depth data;
capturing, by the imaging device during the relative rotation of the object with respect to the imaging device, a first set of visual images of the object;
capturing, by the imaging device during the relative rotation of the object with respect to the imaging device, a first set of depth data regarding the object;
generating a three-dimensional model of the object based at least in part on the first set of visual images and the first set of depth data;
selecting a plurality of orientations for the three-dimensional model;
rendering the three-dimensional model in each of the plurality of orientations;
generating a second set of visual images of the three-dimensional model, wherein each of the visual images of the second set is captured with the three-dimensional model rendered in one of the plurality of orientations;
training a machine learning model to recognize the object based at least in part on at least some of the second set of the visual images and an identifier of the object; and
distributing code for operating the machine learning model to at least one computer device associated with an end user.

19. The computer-implemented method of claim 18, wherein generating the three-dimensional model comprises:
generating a point cloud corresponding to at least a portion of the object based at least in part on the first set of depth data;
tessellating the point cloud; and
patching portions of at least some of the first set of visual images onto the tessellated point cloud.

20. The computer-implemented method of claim 18, wherein the machine learning model is an artificial neural network comprising an input layer having a first plurality of neurons, at least one hidden layer having at least a second plurality of neurons, and an output layer having a third plurality of neurons,
wherein a first connection between at least one of the first plurality of neurons and at least one of the second plurality of neurons in the machine learning model has a first synaptic weight,
wherein a second connection between at least one of the second plurality of neurons and at least one of the third plurality of neurons in the machine learning model has a second synaptic weight, and
wherein training the machine learning model to perform the task comprises:
selecting at least one of the first synaptic weight for the first connection or the second synaptic weight for the second connection based at least in part on at least one of the second set of visual images and the identifier of the object.
